(19) United States
(12) Patent Application Publication
(10) Pub. No.: US 2012/0287065 A1
(43) Pub. Date: Nov. 15, 2012

(54) ELECTRONIC DEVICE

(75) Inventor: Haruyoshi OSHINOME, Kanagawa (JP)

(73) Assignee: KYOCERA CORPORATION, Kyoto (JP)

(21) Appl. No.: 13/467,833

(22) Filed: May 9, 2012

(30) Foreign Application Priority Data
May 10, 2011 (JP) 2011-105167
May 11, 2011 (JP) 2011-106682
Jun. 28, 2011 (JP) 2011-142937
Jun. 28, 2011 (JP) 2011-143341

(51) Int. Cl. G06F 3/041

(52) U.S. Cl. 345/173

(57) ABSTRACT

An electronic device comprises a display unit configured to display an image on a display face; a detecting unit configured to detect a physical quantity which changes according to a distance of a material body from the display unit; and a control unit that enlarges or reduces the image according to the physical quantity detected by the detecting unit such that the display unit display the enlarged or reduced image.

### CROSS-REFERENCE TO RELATED APPLICATION

This application claims priority from Japanese Patent Applications No. 2011-105167 filed on May 10, 2011, No. 2011-106682 filed on May 11, 2011, No. 2011-142937 filed on Jun. 28, 2011 and No. 2011-143341 filed on Jun. 28, 2011, the entire subject matter of which is incorporated herein by reference.

### TECHNICAL FIELD

This disclosure relates to an electronic device having a touch panel.

### BACKGROUND

Now, there is a input device having touch panels include a input device which detects a change in electrostatic capacitance occurring due to approach or contact of a material body such as a user's finger or a stylus in order to detect the position of the material body relative to a touch panel (see JP-A-8-179871).

An object displayed on a touch panel of an electronic device is touch-operated, with a finger, a stylus, or the like, so that user intuitively performs a process relative to the object. JP-A-2010-97326 discloses a technology switching between processes according to various kinds of touch operation by performing the touch operation of long press, short press, and the like.

Meanwhile, JP-A-2010-26638 discloses that the one of portable image display devices has display units disposed at a front face and a rear face of a case, and touch sensor units disposed at four side faces of the case. When two touch sensor units detect a contact moving in a direction away from one corner portion, the portable image display device enlarges an image displayed on a display unit. When two touch sensor units detect a contact moving in a direction approaching one corner portion, the portable image display device reduces an image displayed on a display unit.

Meanwhile, JP-A-2010-33158 discloses that the information processing devices has a display panel configured by a display unit and a light receiving sensor. In a state in which there is an image displayed on the display unit, when a finger rotates in the proximity of the display unit, the information-processing device detects a rotation angle of the finger by the light receiving sensor, and enlarges or reduces the image according to the rotation angle.

Further, with the advancements in virtual reality technology and augmented reality technology, various events is to be artificially experienced. For example, JP-A-2013-011008 discloses a technology possible to artificially experience playing of a musical instrument.

### SUMMARY

However, in a case of the invention disclosed in JP-A-2010-26638 or 2010-33158, the user needs to memorize operation methods for enlarging or reducing images. For this reason, the inventions disclosed in JP-A-2010-26638 and 2010-33158 are not intuitively operated by the user.

One aspect of this disclosure provides an electronic device capable of enlarging or reducing an image by a user's intuitive operation.

In view of the above, an electronic device in one aspect of this disclosure includes a display unit configured to display an image on a display face; a detecting unit configured to detect a physical quantity which changes according to a distance of a material body from the display unit; and a control unit that enlarges or reduces the image according to the physical quantity detected by the detecting unit such that the display unit display the enlarged or reduced image.

This disclosure can provide an electronic device capable of enlarging or reducing an image according to easy operation of a user.

Meanwhile, although touch panels enable intuitive operation on objects, the number of the kinds of detectable touch operations are limited. For this reason, sometimes, touch operation for movement or copy of an object competes with another kind of touch operation. Like the technology disclosed in JP-A-2010-97326, when different kinds of operation are combined, processes assigned to the individual kinds of touch operation increase, and then it is possible to avoid the competition. However, when non-associated kinds of operation are combined, the intuitiveness of operation is likely to be lost.

With considering the above, one aspect of this disclosure provides an electronic device, a control method, and a control program enabling the user to intuitively perform a operation for moving or copying an object, without competing with other kinds of operations.

An electronic device in one aspect of this disclosure comprises: a display unit configured to display an object; a detecting unit configured to detect positions of a first material body and a second material body on the display unit; and a control unit that changes display of the object when the positions of the first material body and the second material body detected by the detecting unit are in the vicinity of the object displayed on the display unit.

This disclosure provides the user with intuitive operation for moving or copying an object, without competing with another kind of operation.

Meanwhile, in the above input device of JP-A-8-179871 having the touch panel, it is unlikely to execute a mouse-over process before the object displayed on the touch panel is selected by touching. An operation to execute the mouse-over process (an operation of placing a cursor, representing the position of the material body, on the object displayed on the touch panel) is competed with a drag-end-drop operation to move the object or to scroll a page. Here, a mouse-over is a moving of a cursor or a pointer displayed on a display unit onto an object according to a material body or the positioning of the material body, and then displays information about the object on the touch panel or changes display of the object (for example, the color of the object) when the cursor or the pointer overlap the object.

One aspect of this disclosure provides an input device capable of executing a mouse-over process, and an electronic device having the input device.

An input device in one aspect of this disclosure comprise: a display unit configured to display an object; a detecting unit configured to detect electrostatic capacitance according to approach or contact of a material body from the display unit; and a control unit configured to determine that the material body is in a proximity state with respect to the display unit when the electrostatic capacitance detected by the detecting unit is a first threshold value or more and is less than a second threshold value, wherein the control unit enables a mouse-over process relative to an object displayed on the display unit when the material body is in the proximity state with respect to the display unit.

This disclosure provides an input device capable of executing a mouse-over process, and an electronic device having the input device.

Meanwhile, when playing a musical instrument, the strength of operation, such as the strength of striking of a keyboard, is to be important. However, since the technology disclosed in JP-A-2011-011008 is for performing artificial experiment by contact with a touch panel, it is difficult to sufficiently give a feeling of actually playing the musical instrument.

One aspect of this disclosure provides an electronic device, a control method, and a control program capable of giving a more real operation feeling.

An electronic device in one aspect of this disclosure comprises: a display unit configured to display an object; an operating unit configured to execute an operation associated with the object; a detecting unit configured to detect a displacement of a material body relative to the object; and a control unit configured to determine strength of an operation on the object based on the displacement detected by the detecting unit, wherein the control unit changes contents of the operation to be executed by the operating unit according to the determined strength.

This disclosure provides an electronic device, a control method, and a control program capable of giving a manipulator a more real operation feeling based on the strength of operation on an object.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a perspective view illustrating an appearance of a portable phone according to a first illustrative embodiment of an electronic device;

FIG. 2 is a block diagram illustrating a functional configuration of the portable phone;

FIGS. 3A and 3B are views illustrating transitions of screens displayed on a display unit;

FIG. 4 is a first view illustrating a screen displayed on the display unit;

FIG. 5 is a second view illustrating the screen displayed on the display unit;

FIG. 6 is a flow chart illustrating an operation of the portable phone;

FIG. 7 is a front view illustrating an appearance of a portable phone terminal according to a second illustrative embodiment;

FIG. 8 is a block diagram illustrating a functional configuration of the portable phone terminal according to the second illustrative embodiment;

FIG. 9 is a view illustrating a movement operation on an object;

FIG. 10 is a view illustrating a movement operation on the object;

FIG. 11 is a view illustrating a movement operation of bringing fingers into contact with a touch panel to confirm a movement destination of an object.

FIG. 12 is a view illustrating the movement operation of bringing the fingers into contact with the touch panel to confirm the movement destination of the object;

FIG. 13 is a flow chart illustrating a process procedure of a movement (copy) process;

FIG. 14 is a view illustrating movement operation in a case where the movement destination is a container object;

FIG. 15 is a view illustrating another selection operation;

FIG. 16 is a view illustrating another selection operation;

FIG. 17 is a front view illustrating an appearance of a portable phone terminal using image acquiring units as a detecting unit;

FIG. 18 is a perspective view illustrating an appearance of a portable phone according to a third illustrative embodiment of an electronic device;

FIG. 19 is a block diagram illustrating a functional configuration of the portable phone;

FIGS. 20A to 20E are views illustrating transitions of screens displayed on a display unit of an input device;

FIG. 21 is a flow chart illustrating an operation of the input device;

FIG. 22 is a front view illustrating an appearance of a portable phone terminal (an electronic device) according to a fourth illustrative embodiment;

FIG. 23 is a block diagram illustrating a functional configuration of the portable phone terminal according to the fourth illustrative embodiment;

FIG. 24 is a view illustrating operation on an object and detection of strength;

FIG. 25 is a view illustrating an example of an object displayed on a display unit;

FIG. 26 is a flow chart illustrating a process procedure of a process of adjusting strength of operation;

FIG. 27 is a view illustrating an example in which the adjusting process is performed for levels of the strength of operation; and

FIG. 28 is a view illustrating detection of operation on an object.

### DETAILED DESCRIPTION

Hereinafter, this disclosure will be described in detail with reference to the accompanying drawings. However, this disclosure is not limited to the following description. In the following description, components include equivalent components, such as components easily supposable by those skilled in the art, and practically identical components. The following description will be made considering a portable phone terminal as an example of an electronic device. However, the electronic device of this disclosure is not limited to the portable phone terminal, but this disclosure can be applied even to a personal handyphone system (PHS), a personal data assistant (PDA), a portable navigation device, a personal computer, a game machine, and the like.

### First Illustrative Embodiment

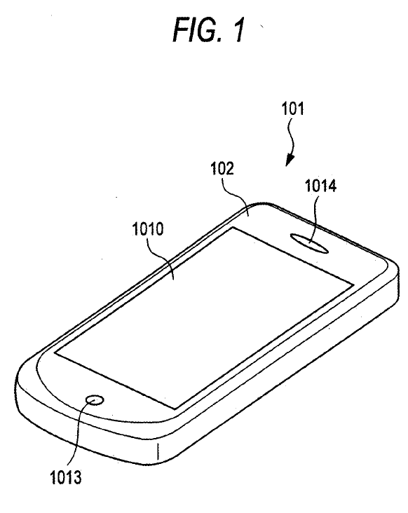

First, a basic structure of a portable phone 101 according to a first illustrative embodiment of an electronic device of this disclosure will be described with reference to FIG. 1. FIG. 1 is a perspective view illustrating an appearance of the portable phone 101 according to the first illustrative embodiment of the electronic device.

The portable phone 101 includes a case 102. At a front portion of the case 102, a touch panel 1010, a microphone 1013, and a receiver 1014 are disposed.

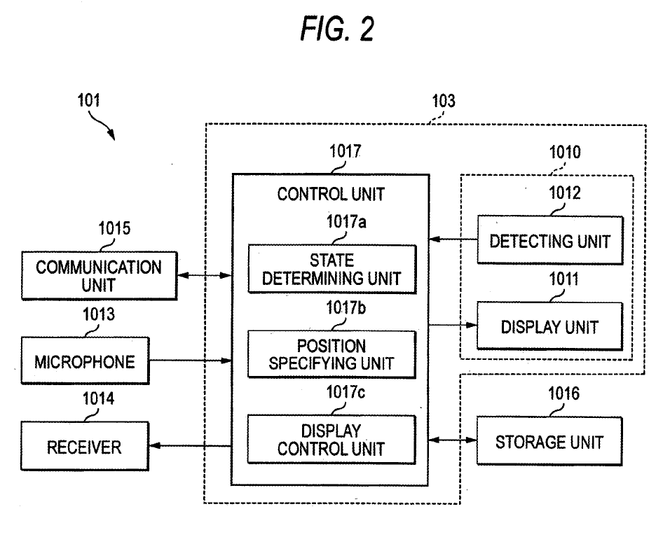

The touch panel 1010 includes a display unit 1011 and a detecting unit 1012 (see FIG. 2). The display unit 1011 includes an image display panel such as a liquid crystal display panel or an organic electro-luminescence (EL) display panel. The detecting unit 1012 is disposed corresponding to a surface of the display unit 1011.

The microphone 1013 is configured to receive a voice of a user of the portable phone 101 when a call.

The receiver 1014 is configured to output the voice of the other party of the user of the portable phone 101.

Next, a functional configuration of the portable phone 101 will be described with reference to FIG. 2. FIG. 2 is a block diagram illustrating the functional configuration of the portable phone 101.

The portable phone 101 includes the touch panel 1010 (including the display unit 1011 and the detecting unit 1012), the microphone 1013, and the receiver 1014 described above. Further, the portable phone 101 includes a communication unit 1015, a storage unit 1016, and a control unit 1017.

The communication unit 1015 includes a main antenna (not shown) and an RF circuit unit (not shown). The communication unit 1015 performs communication with an external apparatus within a predetermined usable frequency band. Specifically, the communication unit 1015 demodulates a signal received by the above-mentioned main antenna, and provides the demodulated signal to the control unit 1017. Also, the communication unit 1015 modulates a signal supplied from the control unit 1017, and transmits the modulated signal to an external apparatus (a base station) through the above-mentioned main antenna.

The storage unit 1016 includes, for example, a working memory, and is used for an arithmetic process of the control unit 1017. Also, the storage unit 1016 stores one or more databases and applications to be executed in the portable phone 101. The storage unit 1016 may double as an installable and removable external memory.

The control unit 1017 controls the entire portable phone 101, and performs control on the display unit 1011 and the communication unit 1015.

Hereinafter, the portable phone 101 according to the first illustrative embodiment of this disclosure will be described in detail. As described above, the portable phone 101 includes the display unit 1011, the detecting unit 1012, and the control unit 1017. The display unit 1011, the detecting unit 1012, and the control unit 1017 configure an input device 103.

The display unit 1011 displays images on a display face. Examples of the images include documents, still images, movies, objects, and the like. The objects are icons having predetermined functions assigned thereto.

The detecting unit 1012 detects a physical quantity which varies according to a distance of a material body from the display unit 1011. The detecting unit 1012 is a touch sensor which is an electrostatic capacitance type, an infrared type, an optical type, or the like. For example, in a case where the detecting unit 1012 is the electrostatic capacitance type, the detecting unit 1012 detects electrostatic capacitance as the physical quantity. Examples of the material body include a user's finger, a stylus, and the like.

The control unit 1017 makes it possible to enlarge or reduce an image according to the physical quantity detected by the detecting unit 1012 and make the display unit 1011 display the enlarged or reduced image. More Specifically, based on the physical quantity detected by the detecting unit 1012, the control unit 1017 determines a contact state in which the material body is in contact with the display unit 1011, or a proximity state in which the material body is positioned in an area at distances of less than a predetermined distance from the display unit 1011, or a non-proximity state in which the material body is positioned in an area at distances of the predetermined distance or more from the display unit 1011. Further, based on the physical quantity detected by the detecting unit 1012, the control unit 1017 specifies the position of the material body with respect to the display unit 1011 in a direction along the display face. When determining that the material body is in the proximity state with respect to the display unit 1011, the control unit 1017 makes it possible to enlarge or reduce the image according to the physical quantity detected by the detecting unit 1012 with centering on the specified position of the material body and make the display unit 1011 display the enlarged or reduced image.

More Specifically, the control unit 1017 includes a state determining unit 1017a, a position specifying unit 1017b, and a display control unit 1017c.

Based on the physical quantity detected by the detecting unit 1012, the state determining unit 1017a determines the contact state in which the material body is in contact with the display unit 1011, or the proximity state in which the material body is positioned in the area at the distances of less than the predetermined distance from the display unit 1011, or the non-proximity state in which the material body is positioned in the area at the distances of the predetermined distance or more from the display unit 1011.

For example, when the physical quantity (for example, electrostatic capacitance) is less than a first threshold value, the state determining unit 1017a determines that the material body is in the non-proximity state with respect to the display unit 1011. When the physical quantity (for example, electrostatic capacitance) is the first threshold value or more and is less than a second threshold value, the state determining unit 1017a determines that the material body is in the proximity state with respect to the display unit 1011. Meanwhile, when the physical quantity (for example, electrostatic capacitance) is the second threshold value or more, the state determining unit 1017a determines that the material body is in the contact state with respect to the display unit 1011.

Based on the physical quantity detected by the detecting unit 1012, the position specifying unit 1017b specifies the position of the material body with respect to the display unit 1011 in the direction along the display face. For example, the position specifying unit 1017b specifies which a coordinate pair in a coordinate system (formed by an X axis and a Y axis) of the detecting unit 1012 the physical quantity has been detected, thereby specifying the position of the material body from the display unit 1011. When the material body has an extent in the direction along the display face of the display unit 1011, the position specifying unit 1017b may specify the center of gravity or center of the extent as the position of the material body, or may specify a top portion of the extent as the position of the material body.

When the state determining unit 1017a determines that the material body is in the proximity state with respect to the display unit 1011, the display control unit 1017c makes it possible to enlarge or reduce the image according to the physical quantity detected by the detecting unit 1012, corresponding to the position of the material body specified by the position specifying unit 1017b, and make the display unit 1011 display the enlarged or reduced image. When the material body approaches or moves away from the display unit 1011 within a range in which the material body is in the proximity state with respect to the display unit 1011, the display control unit 1017c enlarges or reduces the image to be displayed on the display unit 1011.

In this way, when the user moves the material body close to or away from the display unit 1011 (by intuitive operation of the user), the portable phone 101 can enlarge or reduce the image to be displayed on the display unit 1011.

Meanwhile, in a case where the state determining unit 1017a determines that the material body is in the proximity state with respect to the display unit 1011, when the distance of the material body from the display unit 1011 is reduced based on the physical quantity detected by the detecting unit 1012, the display control unit 1017c may enlarges the image; whereas when the distance of the material body from the display unit 1011 increases based on the physical quantity detected by the detecting unit 1012, the display control unit 1017c may reduces the image. In other words, when the physical quantity detected by the detecting unit 1012 represents that the distance between the display unit 1011 and the material body is reduced, the display control unit 1017c enlarges the image to be displayed on the display unit 1011. Meanwhile, when the physical quantity detected by the detecting unit 1011 represents that the distance between the display unit 1011 and the material body increases, the display control unit 1017c reduces the image to be displayed on the display unit 1011.

An image enlargement factor or image reduction factor according to a physical quantity is set in the display control unit 1017c in advance. The image enlargement factor or image reduction factor according to the physical quantity can also be appropriately set by the user.

Therefore, in the case where the material body is in the proximity state with respect to the display unit 1011, when the material body comes close to the display unit 1011, the portable phone 101 can enlarge the image; whereas when the material body moves away from the display unit 1011, the portable phone 101 can reduce the image.

In a case where the state determining unit 1017a determines that the material body is transitioned from the proximity state to the contact state with respect to the display unit 1011, it is preferable that the display control unit 1017c maintains the size of the enlarged image. In a case where the material body comes close to the display unit 1011, the display control unit 1017c gradually enlarges the image to be displayed on the display unit 1011. Meanwhile, in a case where the material body is in contact with the display unit 1011, the display control unit 1017c maintains the horizontal size (enlargement factor) of the enlarged image.

In this way, the portable phone 101 can execute the process according to the distance between the display unit 1011 and the material body.

Meanwhile, in a case where the state determining unit 1017a determines that the material body is transitioned from the contact state to a non-proximity state through the proximity state with respect to the display unit 1011, it is preferable that the display control unit 1017c releases the reduction of the image. When the material body moves away from the display unit 1011, the display control unit 1017c gradually reduces the image displayed on the display unit 1011. Then, when the material body becomes the non-proximity state with respect to the display unit 1011, the display control unit 1017c stops the reduction of the image displayed on the display unit 1011. In other words, when the horizontal size of the image displayed on the display unit 1011 returns to an initial horizontal size (enlargement factor or reduction factor) before the enlargement or reduction of the image has been executed, the display control unit 1017c stops the process of enlarging or reducing the image. In this way, the portable phone 101 can perform the process according to the distance between the display unit 1011 and the material body.

In a case where a time from when the state determining unit 1017a determines that the material body is in the proximity state with respect to the display unit 1011 to when the state determining unit 1017a determines that the material body is in the contact state with respect to the display unit 1011 is a predetermined time or less, it is preferable that the display control unit 1017c does not enlarge or reduce the image.

A time is measured by a timer (not shown). In other words, when it is determined that the material body becomes the proximity state with respect to the display unit 1011, the display control unit 1017c makes the timer start measuring the time. Further, the display control unit 1017c determines whether the time measured by the timer until the material body is contact with the display unit 1011 is a predetermined time or less. When determining that the time measured until the material body is contact with the display unit 1011 is the predetermined time or less, the display control unit 1017c does not enlarge or reduce the image.

Therefore, the portable phone 101 can assign a weight of a predetermined time to a case of enlarging the image.

Also, in the case of enlarging the image, it is preferable that the display control unit 1017c enlarges a predetermined range of the image with centering on the position of the material body specified by the position specifying unit 1017b or the entire image.

Further, in the case of reducing the image, it is preferable that the display control unit 1017c reduces a predetermined range of the image with centering on the position of the material body specified by the position specifying unit 1017b or the entire image.

The outline of the predetermined range (area) is an arbitrary shape such as a circle shape, an ellipse shape, a rectangle shape, or the like. Further, a distance from the position (center of a predetermined range) of the material body to the peripheral edge portion of the predetermined range is set in advance or is appropriately set by the user.

In the case of enlarging or reducing the image, the display control unit 1017c replaces enlarging or reducing the predetermined range of the image with enlarging or reducing the entire image.

In this way, the portable phone 101 can enlarge or reduce the image displayed on the display unit 1011.

In the case where the state determining unit 1017a determines that the material body is in the proximity state with respect to the display unit 1011, when the position specifying unit 1017b determines that the material body is moving with respect to the display unit 1011, it is preferable that the display control unit 1017c changes the center of image enlargement or reduction according to the position of the material body specified by the position specifying unit 1017b.

In the case where the material body is in the proximity state with respect to the display unit 1011, the display control unit 1017c moves the center of the image enlargement according to the movement of the material body such that the current position of the material body becomes the center of the image enlargement. For example, when the material body moves upward on the display unit 1011 along the display face of the display unit 1011, the display control unit 1017c moves the center of the image enlargement upward on the display unit 1011.

In this way, the portable phone 101 can enlarge an image area according to the position of the material body.

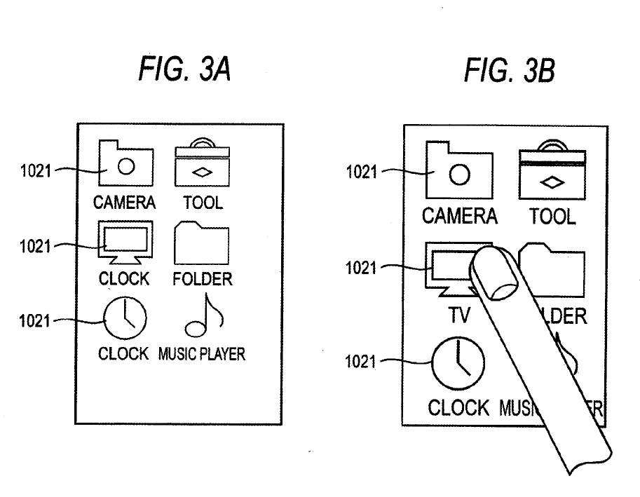

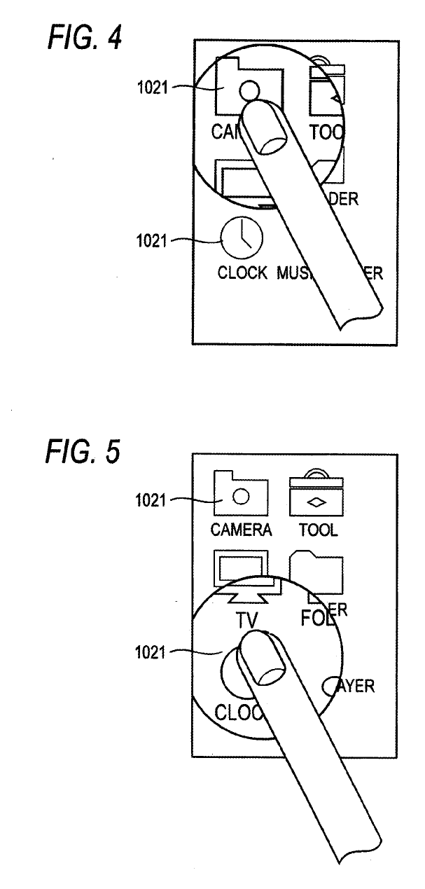

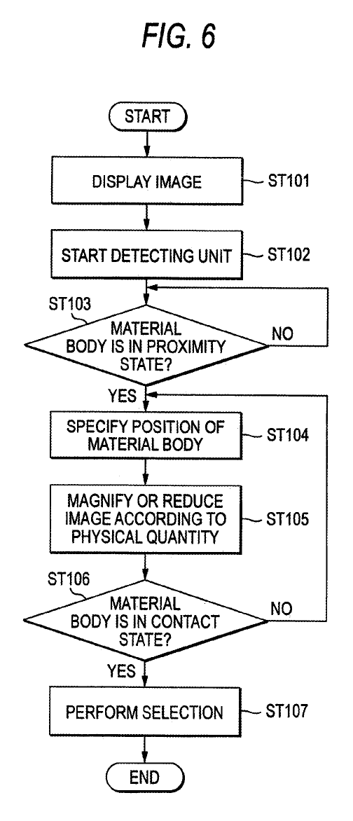

Next, the operation of the portable phone 101 will be described. FIGS. 3A and 3B are views illustrating transitions of screens displayed on the display unit 1011. FIG. 4 is a first view illustrating a screen displayed on the display unit 1011. FIG. 5 is a second view illustrating the screen displayed on the display unit 1011. FIG. 6 is a flow chart illustrating an operation of the portable phone 101.

In step ST101 shown in FIG. 6, the display control unit 1017c makes the display unit 1011 displays an image. For example, as shown in FIG. 3A, the display control unit 1017c makes the display unit 1011 display a plurality of objects 1021.

In step ST102, the detecting unit 1012 starts. Therefore, the detecting unit 1012 can detect the physical quantity.

In step ST103, based on the physical quantity detected by the detecting unit 1012, the state determining unit 1017a determines whether the material body is in the proximity state with respect to the display unit 1011. When the material body is not in the proximity state (NO in step ST103), the determination of the step ST103 is executed again. Meanwhile, when the material body is in the proximity state (YES in step ST103), the process proceeds to step ST104.

In step ST104, the position specifying unit 1017b specifies the position of the material body in the direction along the display face of the display unit 1011.

In step ST105, according to the physical quantity detected by the detecting unit 1012, the display control unit 1017c enlarges or reduces the image displayed on the display unit 1011, with centering on the position of the material body specified in step ST104. The enlarged or reduced image is displayed on the display unit 1011.

For example, as shown in FIG. 3B, when the material body (a user's finger) comes close to the display unit 1011, the display control unit 1017c enlarges the image (objects 1021) and makes the display unit 1011 display the enlarged image. Also, as shown in FIG. 4, when the material body (a user's finger) comes close to the display unit 1011, the display control unit 1017c enlarges a predetermined range of the image (an object 1021), with centering on the position of the material body specified by the position specifying unit 1017b, and makes the display unit 1011 display the enlarged image. Further, as shown in FIG. 5, when the material body (a user's finger) moves, the display control unit 1017c moves the center position of enlargement or reduction on the image (objects 1021) according to the movement of the material body.

In step ST106, based on the physical quantity detected by the detecting unit 1012, the state determining unit 1017a determines whether the material body is in the contact state with respect to the display unit 1011. When the material body is not in the contact state (NO in step ST106), the process returns to the step ST104. Meanwhile, when the material body is in the contact state (YES in step ST106), the process proceeds to step ST107.

In step ST107, the display control unit 1017c determines that any one of the plurality of objects shown in FIG. 3A has been selected, changes the color or size of the object displayed at the position in contact with the material body, and makes the display unit 1011 display the changed image.

As described above, according to the portable phone 101 of the present embodiment, the following effects is to be obtained.

In other words, as the user moves the material body close to or away from the display unit 1011 (by intuitive operation of the user), the portable phone 101 may enlarge or reduce the image displayed on the display unit 1011.

In the case where the material body is in the proximity state with respect to the display unit 1011, when the material body comes close to the display unit 1011, the portable phone 101 may enlarge the image; whereas when the material body moves away from the display unit 1011, the portable phone 101 may reduce the image.

Further, the portable phone 101 may execute a process according to the distance between the display unit 1011 and the material body.

Furthermore, the portable phone 101 may assign a weight of a predetermined time to a case of enlarging or reducing the image.

Therefore, as the user moves the material body close to or away from the display unit 1011 (by easy operation of the user), the portable phone 101 may enlarge or reduce the image displayed on the display unit 1011.

The electronic device of this disclosure is not limited to the above-mentioned portable phone 101, a personal handyphone system (PHS), a personal digital assistant (PDA), a portable game machine, a portable navigation device, and the like is to be used.

Further, the enlargement or reduction factor may be arbitrarily set by the user. Furthermore, according to a change rate of the physical quantity, the enlargement or reduction factor of the image may change. For example, in a case where the material body comes close to the display unit quickly (at a high speed), the enlargement factor may be large; whereas in a case where the material body comes close to the display unit slowly (at a low speed), the enlargement factor may be small.

In the first illustrative embodiment, the detecting unit detects the physical quantity which changes according to the distance of the material body from the display unit. However, the detecting unit may detect the distance of the material body relative to display unit. Further, the distance of the material body from the display unit may be calculated from the physical quantity, or be measured by a distance measuring sensor or an optical sensor. Furthermore, the distance of the material body from the display unit may be a distance within a predetermined range, and the image of the display unit may be enlarged or reduced according to the distance within the predetermined range.

### Second Illustrative Embodiment

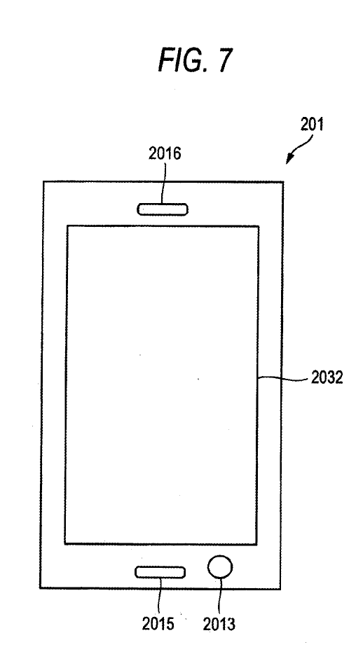

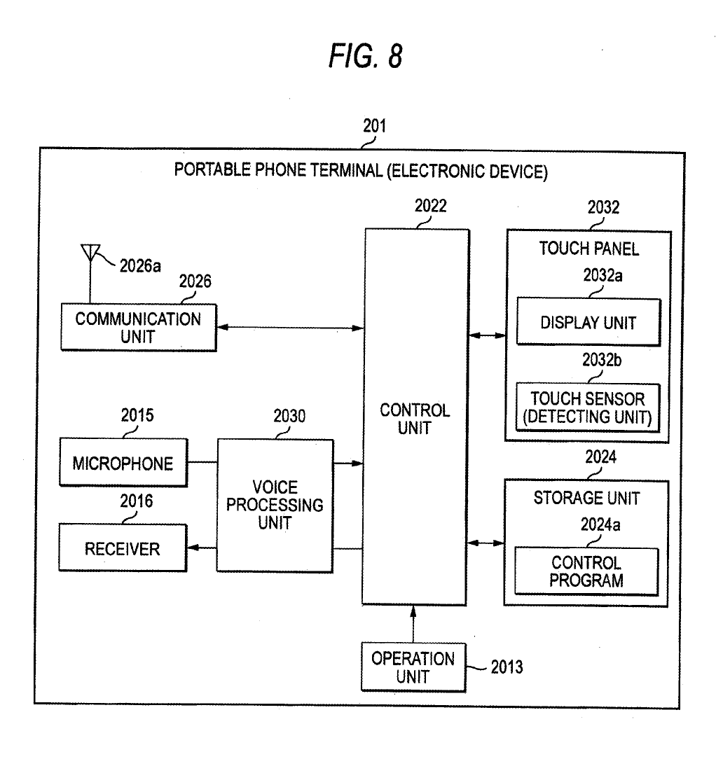

Hereinafter, a second illustrative embodiment will be described in detail with reference to the accompanying drawings. A configuration of a portable phone terminal (electronic device) 201 according to the second illustrative embodiment will be described with reference to FIGS. 7 and 8. FIG. 7 is a front view illustrating an appearance of the portable phone terminal 201. FIG. 8 is a block diagram illustrating a functional configuration of the portable phone terminal 201.

As shown in FIGS. 7 and 8, the portable phone terminal 201 includes a operation unit 2013, a microphone 2015, a receiver 2016, a control unit 2022, a storage unit 2024, a communication unit 2026, a voice processing unit 2030, and a touch panel 2032. Each of the operation unit 2013, the microphone 2015, the receiver 2016, and the touch panel 2032 is partially exposed at the front surface of the portable phone terminal 201.

The operation unit 2013 includes a physical button, and when the button is pushed, the operation unit 2013 outputs a signal corresponding to the button, to the control unit 2022. In an example shown in FIG. 7, the operation unit 2013 has only one button. However, the operation unit 2013 may include an arbitrary number of buttons.

The microphone 2015 acquires an external voice. The receiver 2016 outputs a voice of the other party during a call. The voice processing unit 2030 converts the voice input from the microphone 2015 into a digital signal, and outputs the digital signal to the control unit 2022. Also, the voice processing unit 2030 decodes a digital signal input from the control unit 2022, and outputs the decoded signal to the receiver 2016.

The communication unit 2026 includes an antenna 2026a, and establishes a radio signal line according to a code division multiple access (CDMA) system or the like between the communication unit 2026 and a base station through a channel assigned by the base station. The communication unit 2026 performs call communication and information communication with another device through the radio signal line established between the communication unit 2026 and the base station.

The touch panel 2032 displays various kinds of information such as characters, figures, images, and the like, and detects input operation on displayed icons, buttons, and predetermined areas such as character input areas. The touch panel 2032 is configured by overlapping a display unit 2032a and a touch sensor 2032b.

The display unit 2032a includes a display device such as a liquid crystal display or an organic electro-luminance (EL) panel, and displays various kinds of information according to a control signal input from the control unit 2022.

The touch sensor 2032b detects input operation on a surface of the touch panel 2032, and outputs a signal according to the detected input operation, to the control unit 2022. In other words, the touch sensor 2032b acts as a detecting unit to detect user's operation. The touch sensor 2032b detects various kinds of operation in an electrostatic capacitance type, an optical type, an infrared type, or the like, for instance. The operation which can be detected by the touch sensor 2032b includes tap operation, double-tap operation, long-tap operation, sweep (swipe) operation, flick operation, and the like.

The tap operation is bringing a finger into contact with the touch panel 2032 and then immediately separate the finger from the touch panel 2032. The double-tap operation is to repeat an operation of bringing a finger into contact with the touch panel 2032 and then immediately separating the finger from the touch panel 2032, twice. The long-tap operation is bringing a finger into contact with the touch panel 2032 and maintains the contact state of the finger with the touch panel 2032 for a predetermined time, and then separate the finger from the touch panel 2032. The sweep operation is moving a finger with the finger in contact with the touch panel 2032. In a case where some objects displayed on the touch panel 2032 move along the sweep operation, the sweep operation may be called drag operation. The flick operation is bringing a finger into contact with the touch panel 2032 and move the finger in one direction at a high speed as when quickly sweeping something away.

The control unit 2022 includes a central processing unit (CPU) which is an arithmetic unit, and a memory which is a storage unit, and then CPU performs various functions by executing programs using those hardware resources. Specifically, the control unit 2022 reads a program and data stored the storage unit 2024, develops the program and the data in the memory, and makes the CPU execute commands included in the program developed in the memory. Next, according to the result of the command execution of the CPU, the control unit 2022 reads data from the memory and the storage unit 2024 or controls operations of the display unit 2032a and the like. When executing the commands, the CPU uses the data developed in the memory, and a signal input from the touch sensor 2032b and the like, as part of parameters or a determination condition.

The storage unit 2024 is composed of a non-volatile storage device such as a flash memory, and stores various programs and data. The programs stored in the storage unit 2024 include a control program 2024a. Additionally, the storage unit 2024 may be configured by a combination of a portable storage medium such as a memory card, and a read/write unit configured to read from and write on the storage medium. In this case, the control program 2024a may be stored in the storage medium. The control program 2024a may also be obtained from another device such as a server apparatus by radio communication of the communication unit 2026.

The control program 2024a provides functions regarding various kinds of control for operating the portable phone terminal 201. The functions provided by the control program 2024a include a function of detecting user's operation and performing a process according to the detected operation.

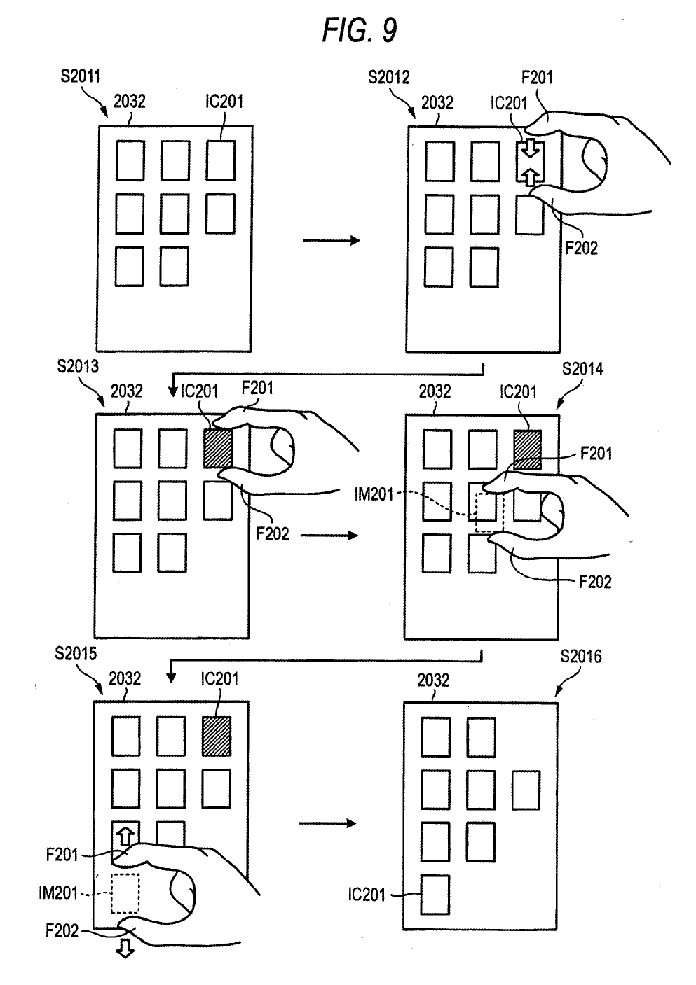

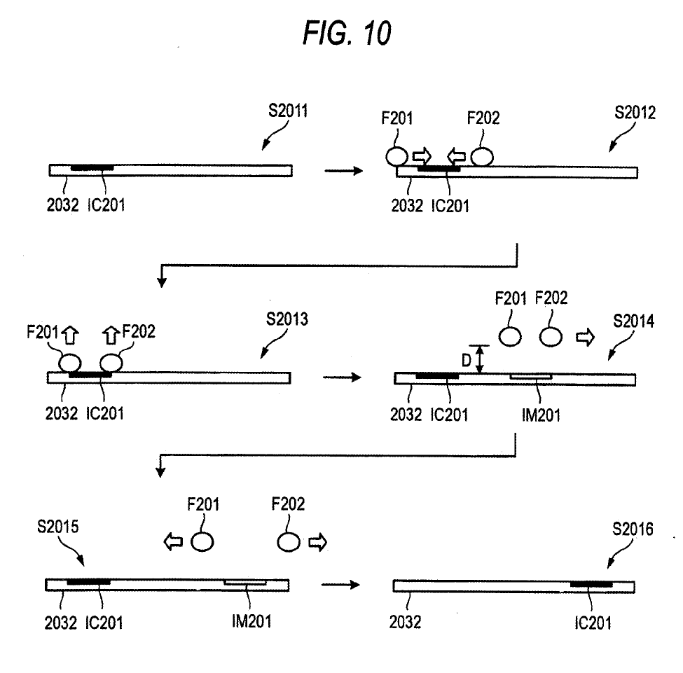

Next, an example of control which is performed based on a function provided by the control program 2024a will be described with reference to FIGS. 9 to 12. FIGS. 9 and 10 are views illustrating movement operation on an object. FIG. 9 illustrates a flow of the movement operation as seen from a front surface of the touch panel 2032. FIG. 10 illustrates the flow of the movement operation as seen from one side of the touch panel 2032. Further, in FIG. 10, the position of the object which is a movement subject is schematically shown. However, as the touch panel 2032 is seen from one side, it may be not necessarily possible to see the position of the object.

In step S211 shown in FIGS. 9 and 204, a standard screen (also referred to as desktop, a home screen, or wallpaper) including a plurality of arranged icons including an icon IC201 is displayed on the touch panel 2032. The icons are objects including images corresponding to data or programs. When predetermined operation such as the tap operation on an icon is detected, the portable phone terminal 201 starts a process corresponding to the icon.

When performing a movement of the icon IC201 to another place, as shown in step S212, the user brings a finger F201 and a finger F202 into contact with the touch panel 2032 in the vicinity of the icon IC201 and moves the finger F201 and the finger F202 close to the center of the display area of the icon IC201. When it is detected that the two material bodies brought into contact with the touch panel 2032 in the vicinity of a selective object such as the icon IC201 get closer to the center of the display area of the object, the portable phone terminal 201 makes the object to a selected state as shown in step S213.

Next, the portable phone terminal 201 changes the display mode of the object, thereby notifying the user that the object has become the selected state. The switch of the object to the selected state is notified, for example, by changing the color or brightness of the entire object or the circumference of the object. Instead of this visual notification, or in addition to this visual notification, notification using sound or vibration may be performed.

The selected state of the icon IC201 is confirmed, as shown in step S214, while maintaining the gap between the finger F201 and the finger F202, the user separates the finger F201 and the finger F202 from the touch panel 2032 and moves the finger F201 and the finger F202 toward the movement destination of the icon IC201.

In a case where any one object becomes a selected state, the portable phone terminal 201 increases the sensitivity of the touch panel 2032. Therefore, the portable phone terminal 201 can detect the positions of the finger F201 and the finger F202 moving with separated from the touch panel 2032. For example, in a case where the detection type of the touch sensor 2032b is an electrostatic capacitance type, since the touch panel 2032 increases the sensitivity, even when a distance from the finger F201 is several centimeters, the touch panel 2032 can detect the position of the finger F201 over the touch panel 2032.

When detecting that the multiple material bodies, which sets the object into the selected state, moves with separated from the touch panel 2032 while keeping the gap between the multiple material bodies, the portable phone terminal 201 displays an image IM201 corresponding to the object on the touch panel 2032 such that the image IM201 follows the movement of the object. For example, the image IM201 is an image having the same appearance as that of the corresponding object, a translucent image of the corresponding object, or a frame having the substantially same size as that of the corresponding object. Since the image IM201 is displayed as described above, the user can accurately see the position of the movement destination of the icon IC201. Instead of the image IM201, the icon IC201 may move along the movement of the material bodies.

When the finger F201 and the finger F202 reach the destination, the user widens the gap between the finger F201 and the finger F202 as shown in step S215. When detecting that the gap between the moved material bodies has become larger than a predetermined distance, the portable phone terminal 201 moves the selected object to the vicinity of the center between the material bodies, and releases the selected state of the object. Next, the portable phone terminal 201 restores the sensitivity of the touch panel 2032. As a result, as shown in step S216, the icon IC201 moves to a position intended by the user. Here, the predetermined distance is, for example, a distance obtained by adding a distance which can unconsciously extend between the fingers, to the size of the object which is the movement subject.

As described above, in the present embodiment, the user can select a desired object as a movement subject by bringing the fingers into contact with the touch panel 2032 in the vicinity of the object and moving the fingers close to the center of the display area of the object. This operation is similar to an operation of picking a real object, and thus is easily and intuitively understood by the user.

Further, in the present embodiment, the user can move the fingers, having selected the object, with separated from the touch panel 2032 while keeping the gap between the fingers, and widen the gap at the desired destination, thereby moving the selected object to the desired destination. This operation is similar to an operation of lifting up, carrying, and dropping the real object at a desired destination, and thus is easily and intuitively understood by the user.

In the standard screen, frequently, the tap operation is assigned to activation of a process corresponding to an object, or the like, and the sweep operation is assigned to transition of the standard screen to another page, or the like. However, the operation of the detection target fingers in the movement operation of the present embodiment do not overlap the operation during the above-mentioned operations according to the related art. Therefore, a control method according to the present embodiment can perform operation for moving an object without competition with operation according to the related art.

Moreover, in the present embodiment, only while the material bodies, which sets the object into the selected state, moves with separated from the touch panel 2032, the sensitivity of the touch panel 2032 increases. Therefore, it is possible to suppress an increase in the power consumption due to the increase in the sensitivity while making it possible to detect the positions of the material bodies moving with separated from the touch panel 2032.

The portable phone terminal 201 receives operations other than the operation shown in FIGS. 9 and 10, as the movement operation on an object. For example, the portable phone terminal 201 receives even an operation of moving the fingers, which set the object into the selected state, moving with separated from the touch panel 2032, and bringing the fingers into contact with the touch panel 2032 to confirm the movement destination of the object, as the movement operation.

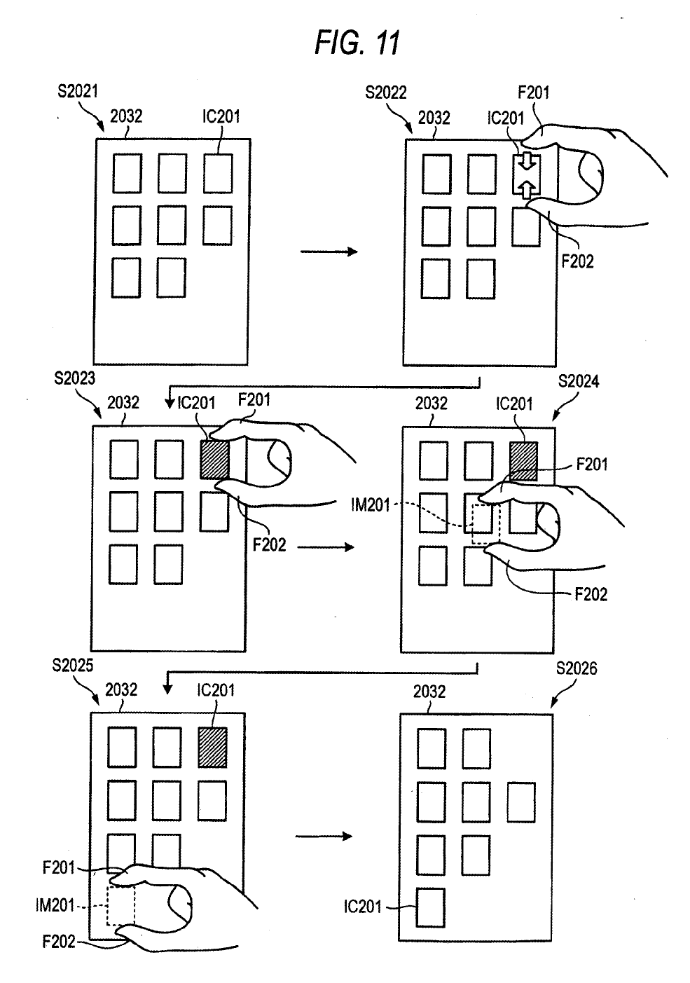

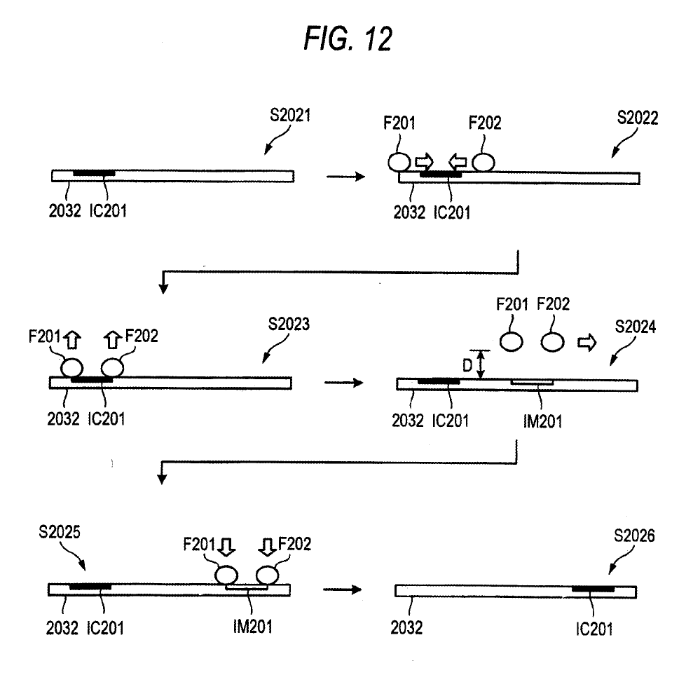

FIGS. 11 and 12 are views illustrating the movement operation of bringing the fingers into contact with the touch panel 2032 to confirm the movement destination of the object. FIG. 11 illustrates a flow of the movement operation as seen from the front surface of the touch panel 2032. FIG. 12 illustrates the flow of the movement operation as seen from the side of the touch panel 2032. Further, in FIG. 12, the position of the object which is a movement subject is schematically shown. However, as the touch panel 2032 is seen from one side, it may be not necessarily possible to see the position of the object.

Steps S221 to S224 are identical to steps S211 to S214 having been already described, and thus will not be described in detail. When the finger F201 and the finger F202 moving with separated from the touch panel 2032 reach the destination, the user brings at least one of the finger F201 and the finger F202 into contact with the touch panel 2032 as shown in step S225.

When detecting that the moved fingers have come into contact with the touch panel 2032 again, the portable phone terminal 201 moves the selected object to the vicinity of the center between the material bodies, and releases the selected state of the object. Next, the portable phone terminal 201 restores the sensitivity of the touch panel 2032. As a result, as shown in step S226, the icon IC201 moves to the position intended by the user.

As described above, in the present embodiment, the user can move the fingers, which is selecting the object, with separated from the touch panel 2032, and bring the fingers into contact with the touch panel 2032 at the desired destination again such that the selected object moves to the desired destination. This operation is similar to an operation of lifting up, carrying, and putting the real object at a desired destination, and thus is easily and intuitively understood by the user. Further, this operation does not compete with the operation during the above-mentioned operation according to the related art.

In FIGS. 9 to 12, the movement operation on the object has been described, and according to the above-mentioned operation, the object is moved. However, according to the above-mentioned operation, the object may be copied. Whether to move or copy an object according to the operation may be determined based on setting performed in advance by the user, or may be determined according to each situation. The determination according to each situation may be performed according to the screen displayed on the touch panel 2032, or may be performed according to other operation (such as pressing the operation unit 2013) performed at the same time or in advance by the user.

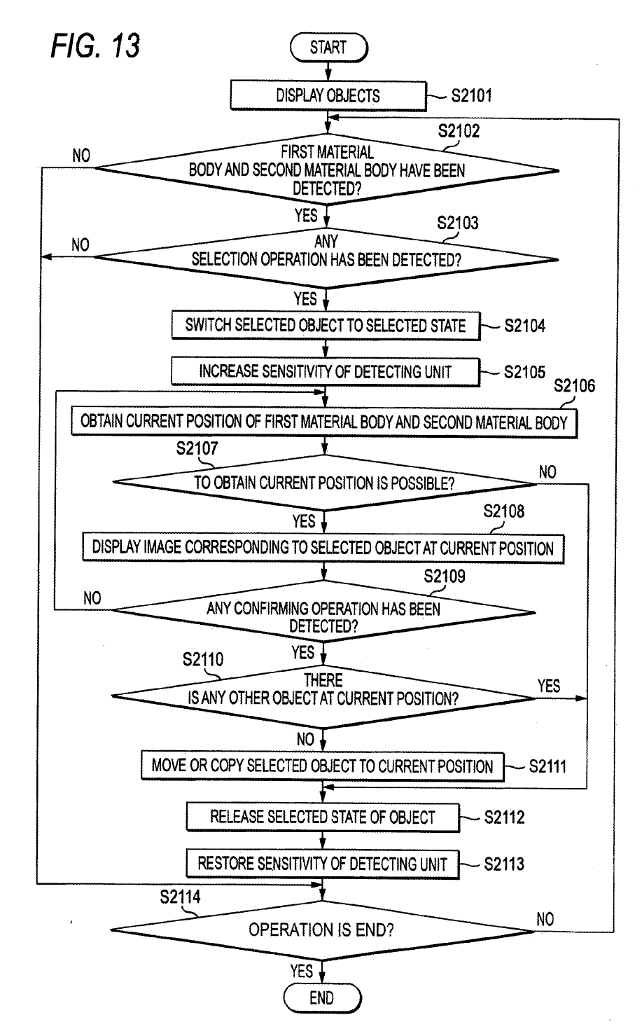

Next, a process procedure of a movement (copy) process will be described with reference to FIG. 13. FIG. 13 is a flow chart illustrating the process procedure of the movement (copy) process. The control unit 2022 executes the control program 2024a so as to perform the process procedure shown in FIG. 13. The process procedure shown in FIG. 13 may be performed in parallel with another process procedure regarding object operation.

As shown in FIG. 13, first, in step S2101, the control unit 2022 displays objects. Next, in step S2102, the control unit 2022 determines whether a first material body and a second material body have been detected by the touch panel 2032. The first material body and the second material body are user's fingers, for in instance.

In a case where the first material body and the second material body have been detected (Yes in step S2102), in step S2103, the control unit 2022 determines whether any selection operation has been detected. The selection operation is an operation for selecting a displayed object. For example, the selection operation is an operation of bringing multiple fingers into contact with the touch panel 2032 in the vicinity of a desired object which is a movement or copy subject, and moving the multiple fingers close to the center of the display area of the object.

In a case where an selection operation has been detected (Yes in step S2103), in step S2104, the control unit 2022 switches the object displayed at the position whether the selection operation has been detected, to a selected state. Next, in step S2105, the control unit 2022 increases the sensitivity of the touch panel (detecting unit) 2032 such that the touch panel can detect the positions of the first material body and the second material body even when the first and second material bodies are separate from the touch panel 2032.

Subsequently, in step S2106, the control unit 2022 obtains the current position of the first material body and the second material body. In a case where it is possible to obtain the current position (Yes in step S2107), in step S2108, the control unit 2022 displays an image corresponding to the selected object, at the current position. Next, in step S2109, the control unit 2022 determines whether any confirming operation has been detected.

The confirming operation is an operation for confirming the movement destination of the object. For example, the confirming operation is an operation of widening the gap between the first material body and the second material body such that the gap becomes larger than the predetermined distance, or an operation of bringing the first material body and the second material body moving with separated from the touch panel 2032, into contact with the touch panel 2032 again.

In a case where any confirming operation has not been detected (No in step S2109), the control unit 2022 repeats step S2106 and the subsequent processes. In a case where a confirming operation has been detected, that is, the movement destination of the object has been confirmed (Yes in step S2109), in step S2110, the control unit 2022 determines whether there is any other object displayed at the current position.

In a case where there is no any other object displayed at the current position (No in step S2110), in step S2111, the control unit 2022 moves or copies the object of the selected state to the current position. Next, the control unit 2022 releases the selected state of the object in step S2112, and restores the sensitivity of the touch panel (detecting unit) 2032 in step S2113.

Subsequently, in step S2114, the control unit 2022 determines whether termination of the operation has been detected. For example, the termination of the operation may be detected in a case where predetermined operation is performed on the operation unit 2013 or may be detected in a case where predetermined operation is performed on the touch panel 2032. In a case where the termination of the operation has been detected (Yes in step S2114), the control unit 2022 finishes the movement (copy) process. Meanwhile, in a case where the termination of operation has not been detected (No in step S2114), the control unit 2022 repeats step S2102 and the subsequent processes.

In a case where the first material body and the second material body are not detected in step S2102 (No in step S2102), or in a case where any selection operation is not detected in step S2103 (No in step S2103), the control unit 2022 repeats step S2114 and the subsequent processes.

In a case where it is not possible to obtain the current position of the first material body and the second material body in step S2107 (No in step S2107), the control unit 2022 cancels the movement or copy of the object, and performs step S2112 and the subsequent processes. The case where it is not possible to obtain the current position of the first material body and the second material body includes a case where the first material body and the second material body are too far with separated from the touch panel 2032.

Also, even in a case where there is any other object at the current position (Yes in step S2110), the control unit 2022 cancels the movement or copy of the object, and performs step S2112 and the subsequent processes.

As described above, in the present embodiment, it is possible to perform movement or copy of an object by intuitive operation, without competition with the operation using a touch panel according to the related art.

A mode of this disclosure according to the second illustrative embodiment can be arbitrarily changed. For example, the control program 2024a according to the above-mentioned embodiment may be divided into a plurality of modules or may be integrated with another program.

Further, in the second illustrative embodiment, the example of moving or copying an icon has been described. However, the object which can be moved or copied using this disclosure is not limit to an icon. For example, this disclosure may be used to move or copy edit elements such as characters, figures, or images in various edit screens, or game items such as trumps or horses.

In the second illustrative embodiment, an example of moving or copying a 2D object has been described. However, this disclosure can be used to move or copy a three-dimensionally (3D) displayed object. Stereoscopic display of an object can be performed on a parallax of left and right eyes. A type of performing stereoscopic display may be a method using glasses, or may be a method capable of being performed by naked eyes. In a case where an object is three-dimensionally displayed, it is preferable that it is possible to detect the selection operation and the confirming operation even when the fingers are not in contact with the touch panel 2032.

In the second illustrative embodiment, selection and movement (copy) of an object is performed in a state in which the gap between the finger F201 and the finger F202 is kept. However, selection and movement (copy) of an object may be performed in a state in which the finger F201 and the finger F202 are in contact with each other.

Further, in the second illustrative embodiment, after performing the selection operation, the user moves the fingers separated from the touch panel to the desired position. However, in the case where the user moves the fingers to the desired position with the fingers in contact with the touch panel, and performs the confirming operation, the object may be moved or copied.

Furthermore, in the second illustrative embodiment, when the object becomes the selected state, the display mode of the object is changed. However, when the fingers, which set the object into the selected state, are separated from the touch panel, the display mode of the object may be changed. For example, animation display may be performed as when the object is curled up with the rising of the fingers. In a case where the touch panel corresponds to 3D display, 3D display may be performed such that the object is disposed on a base surface until the fingers setting the object into the selected state are separated from the touch panel, and the object floats up with the rising of the fingers.

In the above-described second illustrative embodiment, the operation on the object is performed with the fingers. However, the operation on the object may be performed with another part of a human body such as a hand, or a tool such as a rod with a tip charged with static electricity.

Further, in the above-described second illustrative embodiment, in the case where there is any other object at the movement destination, the movement or copy of the object is canceled. However, in a case where the object existing at the movement destination is a container object, movement or copy into the container object may be performed. The container object is an object such as a folder or a trash box capable of storing other objects.

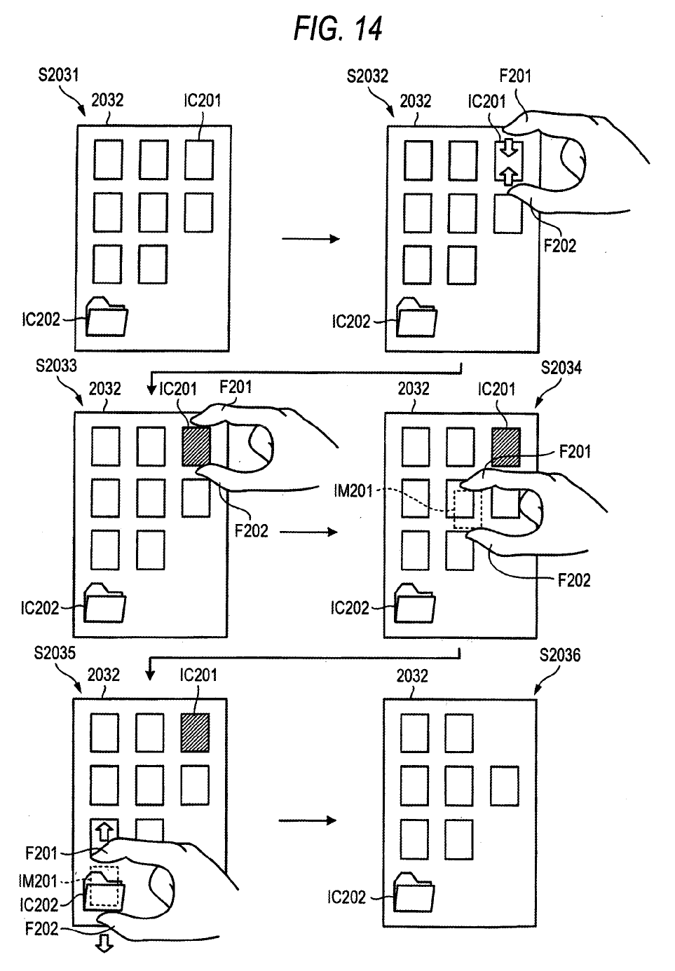

FIG. 14 is a view illustrating a movement operation in a case where the movement destination is a container object. Steps S231 to S234 are identical to steps S211 to S214 having been already described, except that a folder icon IC202 is further displayed on the touch panel 2032. The folder icon IC202 is a container object capable of storing other objects.

When the finger F201 and the finger F202 moving with separated from the touch panel 2032 reach over the folder icon IC202 which is the destination, the user performs a confirming operation as shown in step S235. When detecting the confirming operation over the container object, the portable phone terminal 201 releases the selected state of the object, and stores the object in the container object. Next, the portable phone terminal 201 restores the sensitivity of the touch panel 2032. As a result, as shown in step S236, the icon IC201 is stored in the folder icon IC202, and is not to be displayed any more.

In the second illustrative embodiment, the operation of bringing the fingers into contact with the touch panel in the vicinity of the object, and moving the fingers close to the center of the display area of the object is detected as the selection operation. However, the selection operation which can be detected in this disclosure is not limited to that operation.

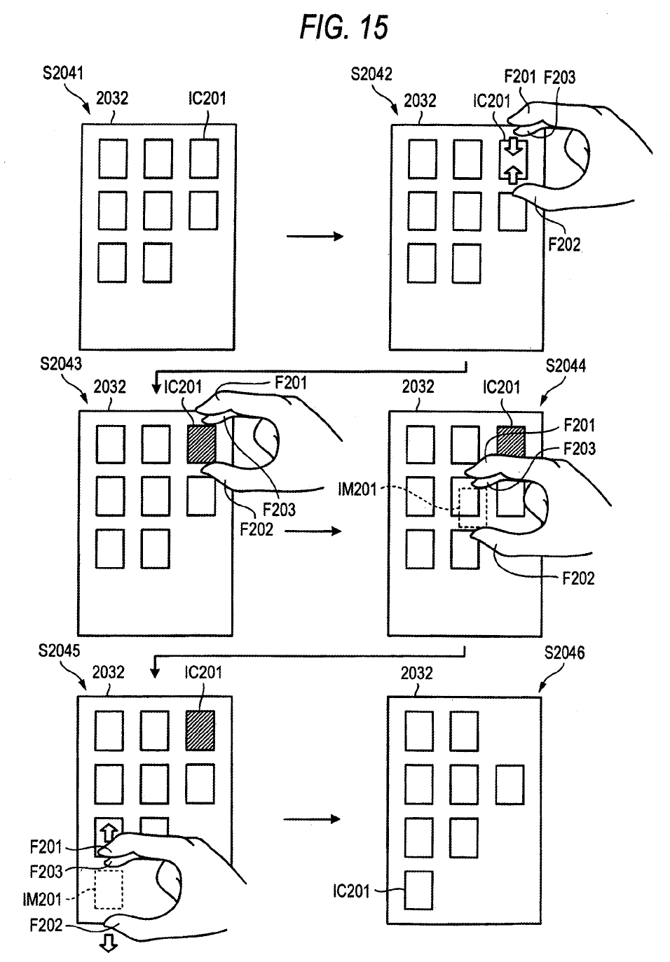

FIG. 15 is a view illustrating another selection operation. In step S241 shown in FIG. 15, similarly to step S211 described above, a standard screen including a plurality of arranged icons including the icon IC201 is displayed on the touch panel 2032. When performing a movement of the icon IC201 to another place, the user brings the finger F201, the finger F202, and a finger F203 into contact with the touch panel 2032 in the vicinity of the icon IC201, and moves the finger F201, the finger F202, and the finger F203 close to the center of the display area of the icon IC201, as shown in step S242.

When detecting that three or more material bodies being contact with the touch panel 2032 in the vicinity of a selectable object such as the icon IC201 get closer to the center of the display area of the object, the portable phone terminal 201 switches the object to the selected state as shown in step S243. The subsequent step S244 to step S246 are identical to step S214 to S216 having been already described, and thus will not be described.

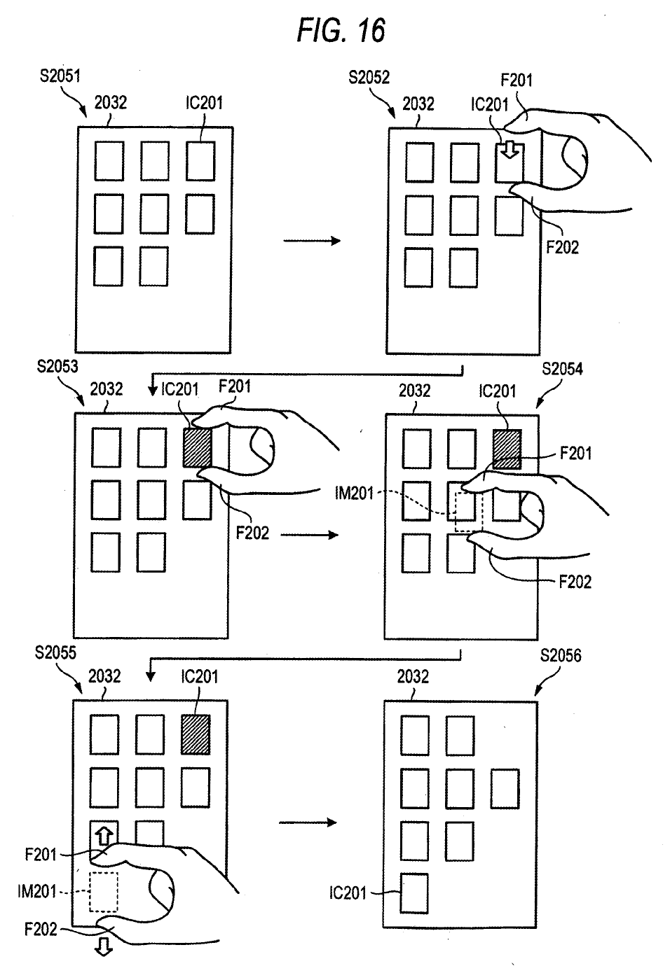

FIG. 16 is a view illustrating another selection operation. In step S251 shown in FIG. 16, similarly to step S211 described above, a standard screen including a plurality of arranged icons including the icon IC201 is displayed on the touch panel 2032. When performing a movement of the icon IC201 to another place, the user brings the finger F201 and the finger F202 into contact with the touch panel 2032 in the vicinity of the icon IC201, and moves the finger F201 close to the finger F202, with the finger F202 in a static state.

When detecting that a part of the plurality of material bodies being contact with the touch panel 2032 in the vicinity of or in the display area of a selectable object such as the icon IC201 is in the static state and the other part gets closer to the stationary material body, the object is set into the selected state as shown in step S253. The subsequent steps S254 to step S256 are identical to steps S214 to S216 having been already described, and thus will not be described.

As shown in FIGS. 15 and 16, the portable phone terminal 201 may receive the operation using three or more fingers, or the operation with one finger at a static state, as the selection operation. The operation using a touch panel according to the related art includes operation (pinch operation) of sweeping two fingers in opposite directions at the same time to enlarge or reduce a screen. However, the selection operations shown in FIGS. 15 and 16 can be distinguished from the operation using two fingers according to the related art.

In addition, for example, the portable phone terminal 201 may receive, as the selection operation, an operation of displacing a plurality of fingers having a gap according to the size of an object in advance such that the object is surrounded by (put between) the fingers, and bringing the fingers into contact with the touch panel. In other words, the portable phone terminal 201 may receive an operation of bringing a plurality of fingers into contact with the vicinity of an object without detecting of the movement of the fingers closer to the center of the display area of the object, as the selection operation. Also, the portable phone terminal 201 may receive as the selection operation, an operation of keeping a plurality of fingers in the vicinity of an object for a predetermined time, and brining the fingers into contact with the touch panel.

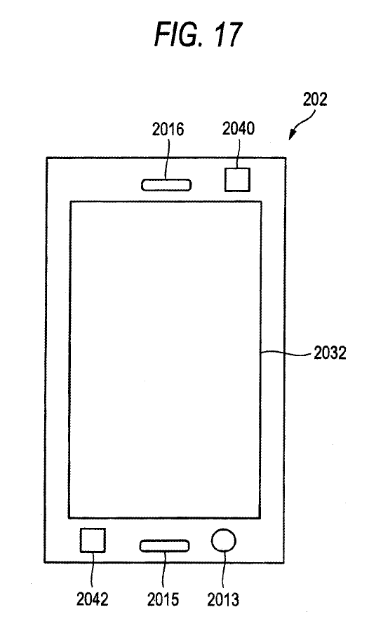

In the second illustrative embodiment, the touch sensor is used as the detecting unit for detecting operation on a displayed object. However, the detecting unit is not limited thereto. For example, an image acquiring unit may be used as the detecting unit. An example using an image acquiring unit as the detecting unit will be described with reference to FIG. 17. FIG. 17 is a front view illustrating an appearance of a portable phone terminal (electronic device) 202 using image acquiring units as the detecting unit. As shown in FIG. 17, the portable phone terminal 202 is different from the portable phone terminal 201 in that the portable phone terminal 202 includes an image acquiring unit 2040 and an image acquiring unit 2042.

The image acquiring units 2040 and 2042 electronically acquire images using imaging sensors such as charge coupled device image sensors (CCD) or complementary metal oxide semiconductors (CMOS). Further, the image acquiring units 2040 and 2042 convert the acquired images into signals, and outputs the signals to the control unit 2022. The image acquiring units 2040 and 2042 also serve as the detecting unit for detecting material bodies operating an object displayed on the touch panel 2032.

Since the portable phone terminal 202 include the multiple image acquiring units, the portable phone terminal 202 can suppress occurrence of a situation in which it is not possible to acquire an image of a material body operating an object due to obstacles such as other fingers. Further, the number of image acquiring units which are provide with the portable phone terminal 202 is not limited to two. Furthermore, it is preferable to set an angle of view and layout for the image acquiring units 2040 and 2042 so that, even when a finger is disposed at any position in a space in a stereoscopic view, the image acquiring units 2040 and 2042 can acquire an image of the finger. Moreover, the image acquiring units 2040 and 2042 may be a device for acquiring an image of visible light, or a device for acquiring an image of invisible light such as infrared light.

### Third Illustrative Embodiment

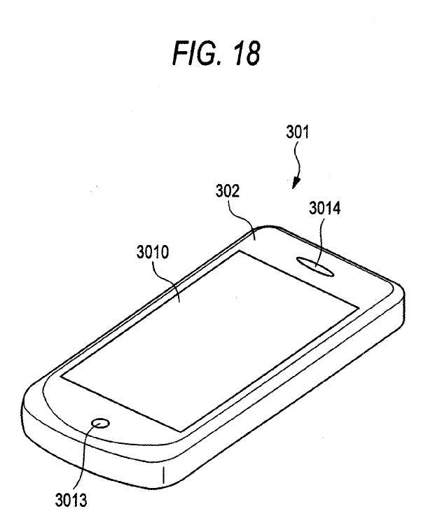

Hereinafter, a third illustrative embodiment of this disclosure will be described. A basic structure of a portable phone 301 according to the third illustrative embodiment of an electronic device of this disclosure will be described with reference to FIG. 18. FIG. 18 is a perspective view illustrating an appearance of the portable phone 301 according to the third illustrative embodiment of the electronic device.

The portable phone 301 includes a case 302. At a front portion of the case 302, a touch panel 3010, a microphone 3013, and a receiver 3014 are disposed.

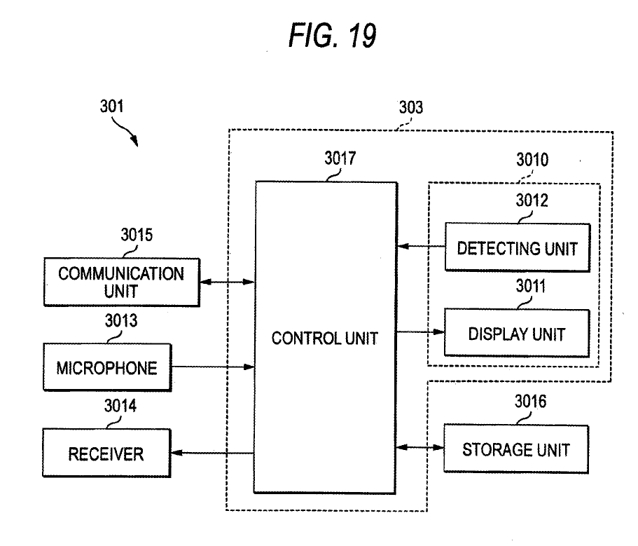

The touch panel 3010 includes a display unit 3011 and a detecting unit 3012 (see FIG. 19). The display unit 3011 includes an image display panel such as a liquid crystal display panel or an organic electro-luminescence (EL) display panel. The detecting unit 3012 is disposed corresponding to a face of the display unit 3011.

The microphone 3013 is used for receiving a voice of a user of the portable phone 301 during a call.

The receiver 3014 is used for outputting the voice of the other party of the user of the portable phone 301.

Next, a functional configuration of the portable phone 301 will be described with reference to FIG. 19. FIG. 19 is a block diagram illustrating the functional configuration of the portable phone 301.

The portable phone 301 includes the touch panel 3010 (including the display unit 3011 and the detecting unit 3012), the microphone 3013, and the receiver 3014 described above. Further, the portable phone 301 includes a communication unit 3015, a storage unit 3016, and a control unit 3017.

The communication unit 3015 includes a main antenna (not shown) and an RF circuit unit (not shown). The communication unit 3015 performs communication with an external apparatus within a predetermined usable frequency band. Specifically, the communication unit 3015 demodulates a signal received by the above-mentioned main antenna, and provides the demodulated signal to the control unit 3017. Also, the communication unit 3015 modulates a signal supplied from the control unit 3017, and transmits the modulated signal to an external apparatus (a base station) through the above-mentioned main antenna.

The storage unit 3016 includes, for example, a working memory, and is used for an arithmetic process of the control unit 3017. Also, the storage unit 3016 stores one or more databases and applications to be executed in the portable phone 301. The storage unit 3016 may double as an installable and removable external memory.

The control unit 3017 controls the portable phone 301, and controls the display unit 3011 and the communication unit 3015.

This portable phone 301 includes an input device 303 configured by some of the above-mentioned components. Hereinafter, the input device 303 according to the embodiment of this disclosure will be described.

The input device 303 includes the display unit 3011, the detecting unit 3012, and the control unit 3017.

The display unit 3011 displays an object. The display unit 3011 can display one or more objects. An object is an image such as an icon. The object may have a predetermined function assigned thereto. For example, the object may have a camera function assigned thereto. In a case where the object having the camera function assigned thereto is selected and determined, the control unit 3017 (to be described below) executes the camera function for acquiring still images or movies of a subject for photography.

The detecting unit 3012 detects a material body in the proximity of the display unit 3011. More Specifically, the detecting unit 3012 detects electrostatic capacitance occurring due to approach or contact of a material body from the display unit 3011. The detecting unit 3012 is an electrostatic capacitance type touch sensor. The detecting unit 3012 detects electrostatic capacitance according to the distance of the material body from the display unit 3011. The material body may be a user's finger, a stylus, or the like.

When the detecting unit 3012 detects approach of a material body to the display unit 3011, the control unit 3017 executes a mouse-over process with respect to the object displayed on the display unit 3011. More Specifically, when the electrostatic capacitance detected by the detecting unit 3012 is a first threshold value or more and is less than a second threshold value, the control unit 3017 determines that the material body is in a proximity state with respect to the display unit 3011, and enables the mouse-over process with respect to the object displayed on the display unit 3011 when the material body is in the proximity of the display unit 3011.

The first threshold value becomes a criterion for distinguishing the proximity state in which the material body is positioned in an area at distances of less than a predetermined distance from the display unit 3011 from a non-proximity state in which the material body is positioned in an area at distances of the predetermined distance or more from the display unit 3011. When the electrostatic capacitance is the first threshold value or more, and is less than the second threshold value (to be described below), the material body is in the proximity state. Meanwhile, when the electrostatic capacitance is less than the first threshold value, the material body is in the non-proximity state.

The second threshold value becomes a criterion for distinguishing a contact state in which the material body is in contact with the display unit 3011 from the proximity state. When the electrostatic capacitance is the second threshold value or more, the material body is in the contact state. Meanwhile, when the electrostatic capacitance is less than the second threshold value, the material body is in the proximity state.

The mouse-over is a movement of a cursor or a pointer displayed on the display unit 3011 onto the object according to the material body or the position of the material body, and display notes on the object pointed by the cursor displayed on the display unit 3011 according to the material body or the position of the material body, or change display of the object (for example, the color of the object).

Therefore, in a case where the material body is in the proximity state, the input device 303 can perform the mouse-over process.

When the electrostatic capacitance detected by the detecting unit 3012 is the second threshold value or more, the control unit 3017 determines that the material body is in contact with the display unit 3011. Further, when the material body is in contact with the display unit 3011, and the position of the material body in a direction along a display face of the display unit 3011 determined based on the detection result of the detecting unit 3012 overlaps the object, the control unit 3017 selects that object.

In other words, when the material body comes into contact with the display unit 3011 so that the material body overlaps the object displayed on the display unit 3011, the control unit 3017 selects the object in contact with the material body. When the object is selected, the control unit 3017 changes the display mode of the object from a first display mode to a second display mode. Here, the first display mode is a normal display mode of the object. The second display mode is a display mode of the object in which the object may be displayed in a color different from that in the first display mode or in a size different from that in the first display mode, for instance.

Therefore, when the material body comes into contact with the object displayed on the display unit 3011 so that the material body overlaps the object, the input device 303 can select the object. Further, since the input device 303 selects the object displayed on the display unit 3011 when the material body comes into contact with the object so that the material body overlaps the object, it is possible to distinguish the selecting process from the above-mentioned mouse-over process.

In a state where the object has been selected, when the electrostatic capacitance detected by the detecting unit 3012 becomes less than the second threshold value, the control unit 3017 performs the function assigned to the selected object. In other words, when the material body comes into contact with the object displayed on the display unit 3011 so that the material body overlaps the object, the object is selected, and then when the material body is separated from the display unit 3011, the control unit 3017 executes the function assigned to the selected object.

For example, when the material body comes into contact with an object having a camera function assigned thereto, and then is separated from the object such that the object is determined, the control unit 3017 makes the camera function be executed.

In this way, the input device 303 can determine an object. When the material body comes into contact with an object displayed on the display unit 3011, and then is separated from the display unit 3011, the input device 303 determines the object. Therefore, it is possible to distinguish the determining process from the above-mentioned mouse-over process (in a case where the material body transitions from the proximity state to the non-proximity state with respect to the display unit 3011).

Also, it is preferable that the detecting unit 3012 switches between a high-sensitivity mode in which sensitivity to detect the electrostatic capacitance is high, and a low-sensitivity mode in which sensitivity to detect the electrostatic capacitance is lower than that in the high-sensitivity mode. In this case, when the electrostatic capacitance detected by the detecting unit 3012 is less than the second threshold value, the control unit 3017 sets the detecting unit 3012 to the high-sensitivity mode; whereas when the electrostatic capacitance detected by the detecting unit 3012 is the second threshold value or more, the control unit 3017 sets the detecting unit 3012 to the low-sensitivity mode.

In a case where the material body comes into contact with the touch panel 3010, it is easy for the detecting unit 3012 to detect the electrostatic capacitance. Therefore, in the case where the material body comes into contact with the touch panel 3010, the detecting unit 3012 is set to the low-sensitivity mode. Meanwhile, in a case where the material body is not in contact with the touch panel 3010 (the proximity state and the non-proximity state), it is more difficult for the detecting unit 3012 to detect the electrostatic capacitance, as compared to a case where the material body is in the contact state. Therefore, in the case where the material body is not in contact with the touch panel 3010, the detecting unit 3012 is set to the high-sensitivity mode.

As described above, when the electrostatic capacitance detected by the detecting unit 3012 is less than the second threshold value, the input device 303 sets the detecting unit 3012 to the high-sensitivity mode; whereas when the electrostatic capacitance detected by the detecting unit 3012 is the second threshold value or more, the input device 303 sets the detecting unit 3012 to the low-sensitivity mode. In this way, the input device 303 sets the detecting unit 3012 to sensitivity according to the state (the contact state, the proximity state, or the non-proximity state) of the material body. Therefore, it is possible to reliably detect the material body. Further, in the case where the material body is in the contact state, since the input device 303 sets the detecting unit 3012 to the low-sensitivity mode, it is possible to reduce power consumption.

In a case where the electrostatic capacitance detected by the detecting unit 3012 is the first threshold value or more, it is preferable that the control unit 3017 makes the cursor be displayed at the position of a top portion of the material body in the direction along the display face of the display unit 3011.

The control unit 3017 specifies the position of the material body in the direction along the display face of the display unit 3011, based on the electrostatic capacitance detected by the detecting unit 3012. Here, for example, in a case where the material body is a user's finger, the specified position of the material body has an extent in the direction along the display face. Therefore, the control unit 3017 specifies the outline of the material body based on the specified position of the material body (which is a user's finger, for instance), and determines the top portion of the material body. For example, the control unit 3017 determines a portion where the specified outline of the material body is the thinnest, as the top portion of the material body. Then, the control unit 3017 makes the cursor be displayed at the position of the specified top portion of the material body. The shape of the cursor may be an arbitrary shape such as an arrow shape. The color of the cursor may be an arbitrary color. However, for example, when the cursor may have a color (for example, a complementary color) different from a background color (a color of wallpaper) of the display unit 3011, the user can easily and visually recognize the cursor.

As described above, in the case where the electrostatic capacitance detected by the detecting unit 3012 is the first threshold value or more, the input device 303 makes the cursor be displayed at the position of the top portion of the material body in the direction along the display face of the display unit 3011. In this way, the input device 303 can indicate the position of the material body in the direction along the display face of the display unit 3011, by the curser, such that the user can easily see the position of the material body.

Also, it is preferable that the control unit 3017 executes the mouse-over process when a predetermined time elapses from when the electrostatic capacitance detected by the detecting unit 3012 becomes the first threshold value or more. In other words, when the material body transitions from the non-proximity state to the proximity state with respect to the display unit 3011, the control unit 3017 provides a time lag until the mouse-over process is executed.

For example, a time is measured by a timer (not shown). When the electrostatic capacitance detected by the detecting unit 3012 becomes the first threshold value or more, the control unit 3017 controls the timer so that the timer starts measuring the time. Next, when the time measured by the timer elapses a predetermined time, the control unit 3017 can execute the mouse-over process.

Even in the case where the material body momentarily transitions from the non-proximity state to the proximity state with respect to the display unit 3011, when the mouse-over process is executed, it is difficult for the user to see the screen. According to the above configuration, the input device 303 can suppress occurrence of that difficulty in seeing the screen.

Moreover, when the mouse-over process is being executed, when it is determined based on the detection result of the detecting unit 3012 that a new material body different from the material body corresponding to the mouse-over process has become the proximity state or the contact state, it is preferable that the control unit 3017 cancels a process relative to the new material body.

In other words, when a first material body becomes the proximity state or the contact state with respect to the display unit 3011, the control unit 3017 performs the mouse-over process or the object selecting process. When this process is being executed, if a second material body becomes the proximity state or the contact state with respect to the display unit 3011, the control unit 3017 does not execute a mouse-over process or an object selecting process based on the second material body. In this case, the control unit 3017 cancels the electrostatic capacitance detected based on the second material body by the detecting unit 3012.

Therefore, the input device 303 can execute only the process relative to the first material body. Moreover, since the input device 303 executes only the process relative to the first material body, it is possible to prevent the cursor from oscillating between the first material body and the second material body.

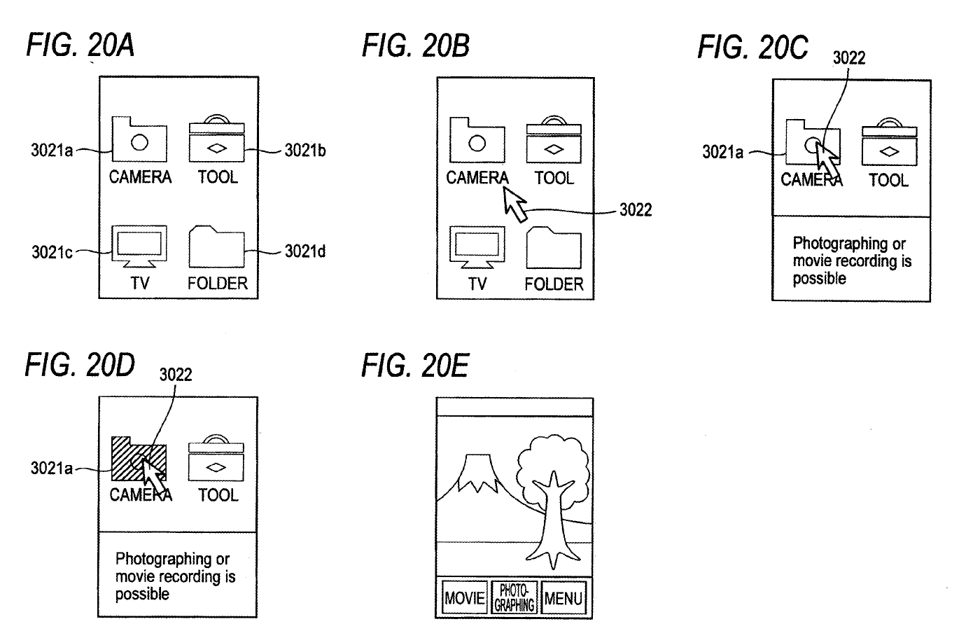

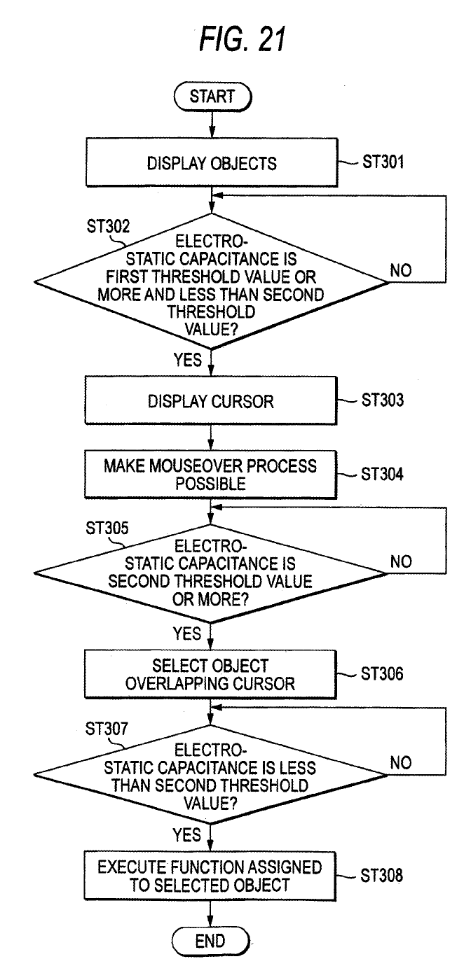

Next, an operation of the input device 303 will be described. FIGS. 20A to 20E are views illustrating transitions of screens displayed on the display unit 3011 of the input device 303. FIG. 21 is a flow chart illustrating the operation of the input device 303.

In a step ST301 shown in FIG. 21, in response to predetermined operation, the control unit 3017 makes the display unit 3011 display objects. For example, as shown in FIG. 20A, the control unit 3017 makes the display unit 3011 display an object (camera object 3021a) having a camera function assigned thereto, an object (tool object 3021b) having a function which has been assigned thereto for selecting and starting any one of various applications, an object (TV object 3021c) having a TV function assigned thereto, and an object (folder object 3021d) having a function which has been assigned thereto for reproducing images and the like acquired by a camera unit (not shown).

In step ST302, the control unit 3017 determines whether the electrostatic capacitance detected by the detecting unit 3012 is the first threshold value or more and is less than the second threshold value. When the electrostatic capacitance is not the first threshold value or more and is not less than the second threshold value (NO in step ST302), the determination of the step ST302 is preformed again. When the electrostatic capacitance is the first threshold value or more and is less than the second threshold value (YES in step ST302), the process proceeds to step ST303.

In step ST303, the control unit 3017 makes the display unit 3011 display a cursor 3022 corresponding to the position of the material body (for example, the position of the top portion of the material body) in the direction along the display face of the display unit 3011. For example, as shown in FIG. 20B, the control unit 3017 makes the display unit 3011 display an arrow-shaped cursor 3022.

In step ST304, the control unit 3017 makes it possible to execute the mouse-over process. In other words, when the position of the material body in the direction along the display face of the display unit 3011 overlaps the position (area) of an object displayed on the display unit 3011, the control unit 3017 performs a mouse-over process. For example, as shown in FIG. 20C, when the cursor 3022 overlaps the camera object 3021a, the control unit 3017 makes the display unit 3011 display an explanation of the function assigned to the camera object 3021a, that is, ‘PHOTOGRAPHING OR MOVIE RECORDING IS POSSIBLE’.

In step ST305, the control unit 3017 determines whether the electronic file detected by the detecting unit 3012 is the second threshold value or more. When the electrostatic capacitance is less than the second threshold value (NO in step ST305), the determination of step ST305 is executed again. Meanwhile, when the electrostatic capacitance is the second threshold value or more (YES in step ST305), the process proceeds to step ST306.

In step ST306, the control unit 3017 selects an object overlapping the cursor 3022. For example, as shown in FIG. 20D, when the cursor 3022 overlaps the camera object 3021a, the control unit 3017 selects the camera object 3021a. Further, in the case shown in FIG. 20D, the control unit 3017 makes the display unit 3011 display the selected object in a color different from that before the selection.

In step ST307, the control unit 3017 determines whether the electrostatic capacitance detected by the detecting unit 3012 is less than the second threshold value. When the electrostatic capacitance is not less than the second threshold value (NO in step ST307), the determination of step ST307 is executed again. Meanwhile, when the electrostatic capacitance is less than the second threshold value (YES in step ST307), the process proceeds to step ST308.

In step ST308, the control unit 3017 determines the selected object, and executes the function assigned to the determined object. For example, when determining the camera object 3021a, the control unit 3017 executes the camera function and makes the display unit 3011 display a screen for photographing a subject for photography as shown in FIG. 20E.

As described above, according to the input device 303 of the present embodiment, the following effects can be obtained.

In other words, when the material body is in the proximity state, the input device 303 can execute the mouse-over process.

Also, when the material body comes into contact with an object displayed on the display unit 3011 so that the material body overlaps the object, the input device 303 can select the object. Further, since the input device 303 selects an object displayed on the display unit 3011 when the material body comes into contact with the object so that the material body overlaps the object, the input device 303 can distinguish the selecting process from the above-mentioned mouse-over process.

Also, the input device 303 can determine an object. When the material body comes into contact with the object displayed on the display unit 3011 so that the material body overlaps the object, and then is separated from the touch panel 3010, the input device 303 determines the object. Therefore, the input device 303 can distinguish the determining process from the above-mentioned mouse-over process (in the case where the material body transitions from the proximity state to the non-proximity state with respect to the display unit 3011).

Also, when the electrostatic capacitance detected by the detecting unit 3012 becomes less than the second threshold value, the input device 303 sets the detecting unit 3012 to the high-sensitivity mode; whereas when the electrostatic capacitance detected by the detecting unit 3012 becomes the second threshold value or more, the input device 303 sets the detecting unit 3012 to the low-sensitivity mode. In this way, the input device 303 sets the detecting unit 3012 to sensitivity according to the state (the contact state, the proximity state, or the non-proximity state) of the material body. Therefore, it is possible to reliably detect the material body. In the case where the material body is in the contact state, the input device 303 can set the detecting unit 3012 to the low-sensitivity mode, thereby reducing power consumption.

Moreover, when the electrostatic capacitance detected by the detecting unit 3012 is the first threshold value or more, the input device 303 makes the cursor be displayed at the position of the top portion of the material body in the direction along the display face of the display unit 3011. Therefore, the input device 303 can indicate the position of the material body in the direction along the display face of the display unit 3011, by the cursor, such that the user can easily see the position of the material body.

In the third illustrative embodiment, the case of using the input device 303 in the portable phone 301 has been described as an example. However, the electronic device of this disclosure is not limited to the embodiment, but may be applied even to a personal handyphone system (PHS), a personal digital assistant (PDA), a portable game machine, a portable navigation device, and the like.

Also, in the third illustrative embodiment, the color of an object is changed when the object is selected. However, the color of an object displayed on the display unit may be changed when the position of the material body overlaps the position of the object in a state where a mouse-over process is executable.

Further, in the third illustrative embodiment, the detecting unit 3012 is an electrostatic capacitance type touch sensor. However, this disclosure is not limited thereto, but can be applied even to an optical touch sensor or an infrared type touch sensor.

### Fourth Illustrative Embodiment

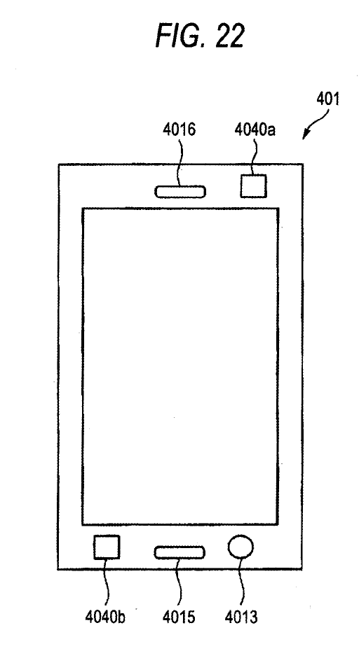

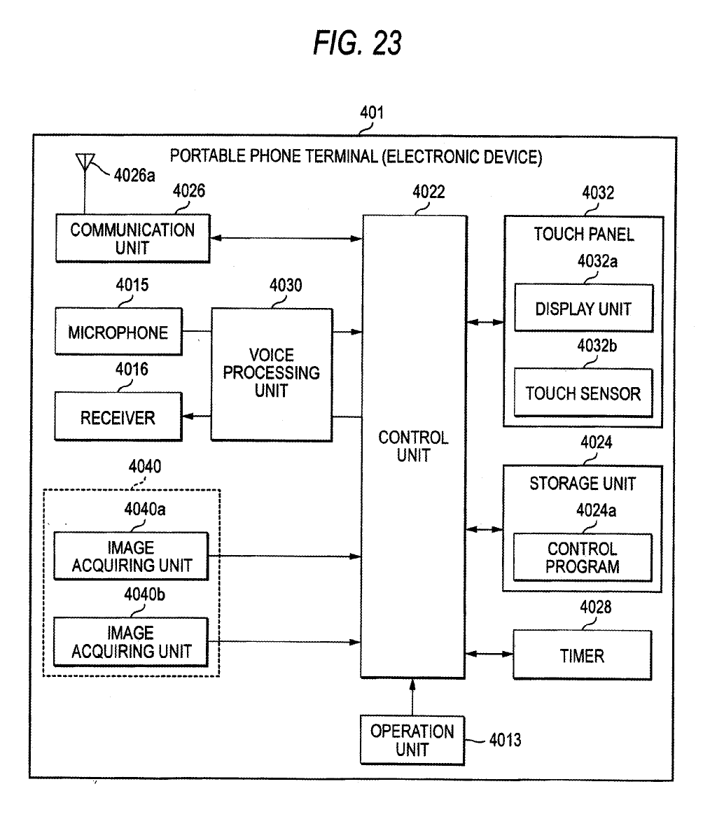

Hereinafter, a third illustrative embodiment of this disclosure will be described. A configuration of a portable phone terminal (electronic device) 401 according to the present embodiment will be described with reference to FIGS. 22 and 23. FIG. 22 is a front view illustrating an appearance of the portable phone terminal 401. FIG. 23 is a block diagram illustrating a functional configuration of the portable phone terminal 401.

As shown in FIGS. 22 and 23, the portable phone terminal 401 includes a operation unit 4013, a microphone 4015, a receiver 4016, a control unit 4022, a storage unit 4024, a communication unit 4026, a timer 4028, a voice processing unit 4030, a touch panel 4032, and an image acquiring unit 4040. Each of the operation unit 4013, the microphone 4015, the receiver 4016, the touch panel 4032, and the image acquiring unit 4040 is partially exposed at the front face of the portable phone terminal 401.

The operation unit 4013 includes a physical button, and when the button is pushed, the operation unit 4013 outputs a signal corresponding to the button, to the control unit 4022. In an example shown in FIG. 22, the operation unit 4013 has only one button. However, the operation unit 4013 may include a plurality of buttons.

The microphone 4015 acquires an external voice. The receiver 4016 outputs a voice of the other party during a call. The voice processing unit 4030 converts the voice input from the microphone 4015 into a digital signal, and outputs the digital signal to the control unit 4022. Also, the voice processing unit 4030 decodes a digital signal input from the control unit 4022, and outputs the decoded signal to the receiver 4016.

The communication unit 4026 includes an antenna 4026a, and establishes a radio signal line according to a code division multiple access (CDMA) type or the like between the communication unit 4026 and a base station through a channel assigned by the base station. The communication unit 4026 performs call communication and information communication with another device through the radio signal line established between the communication unit 4026 and the base station. The timer 4028 detects an elapsed time based on a reference clock or the like.

The touch panel 4032 displays various kinds of information such as characters, figures, images, and the like, and detects input operation on displayed icons, buttons, and predetermined areas such as character input areas. The touch panel 4032 is configured by overlapping a display unit 4032a and a touch sensor 4032b.

The display unit 4032a includes a display device such as a liquid crystal display or an organic electro-luminance (EL) panel, and displays various kinds of information according to a control signal input from the control unit 4022. The touch sensor 4032b detects input operation on a face of the touch panel 4032, and outputs a signal according to the detected input operation, to the control unit 4022. In the present embodiment, it is assumed that the touch sensor 4032b is an electrostatic capacitance type sensor.

The touch sensor 4032b can detect not only input operation on the face of the touch panel 4032 but also input operation performed in a predetermined space separated from the face of the touch panel 4032. In other words, the touch sensor 4032b can detect input operation not only in a case where a material body is in contact with the touch panel 4032 but also in a case where the material body is not in contact with the touch panel 4032. Therefore, when the sensitivity of the touch sensor 4032b is adjusted, it is possible to detect movement of a finger in an X-axis direction, a Y-axis direction, and a Z-axis direction even when the material body is not in contact with the touch panel 4032.

The image acquiring unit 4040 electronically acquires images by an image acquiring sensor. In the present embodiment, the image acquiring unit 4040 is configured by an image acquiring unit 4040a and an image acquiring unit 4040b disposed diagonally at the face where the touch panel 4032 is provided. However, the image acquiring unit 4040 does not necessarily need to be configured by a plurality of image acquiring unit. Also, it is preferable to set an angle of view and layout for the image acquiring unit 4040 such that, even when a finger is disposed at any position on the touch panel 4032, the image acquiring unit 4040 can acquire an image of the finger. The image acquiring unit 4040 may be a device for acquiring an image of visible light, or a device for acquiring an image of invisible light such as infrared light.

The control unit 4022 includes a central processing unit (CPU) which is an arithmetic unit, and a memory which is a storage unit, and performs various functions by executing programs using those hardware resources. Specifically, the control unit 4022 reads a program and data stored the storage unit 4024, develops the program and the data in the memory, and makes the CPU execute commands included in the program developed in the memory. Next, according to the result of the command execution of the CPU, the control unit 4022 reads data from the memory and the storage unit 4024 or controls operations of the communication unit 4026, the display unit 4032a, and the like. When executing the commands, the CPU uses the data developed in the memory, and a signal input from the touch sensor 4032b and the like, as part of parameters or a determination condition.

The storage unit 4024 is configured by a non-volatile storage device such as a flash memory, and stores various programs and data. The programs stored in the storage unit 4024 include a control program 4024a. Alternatively, the storage unit 4024 may be configured by a combination of a portable storage medium such as a memory card, and a read/write unit configured to read from and write on the storage medium. In this case, the control program 4024a may be stored in the storage medium. The control program 4024a may be obtained from another device such as a server apparatus by radio communication of the communication unit 4026.

The control program 4024a provides functions regarding various kinds of control for operating the portable phone terminal 401. The functions provided by the control program 4024a include a function of controlling display of an object on the touch panel 4032, and a function of detecting the strength of operation of a user on the object displayed on the touch panel 4032.

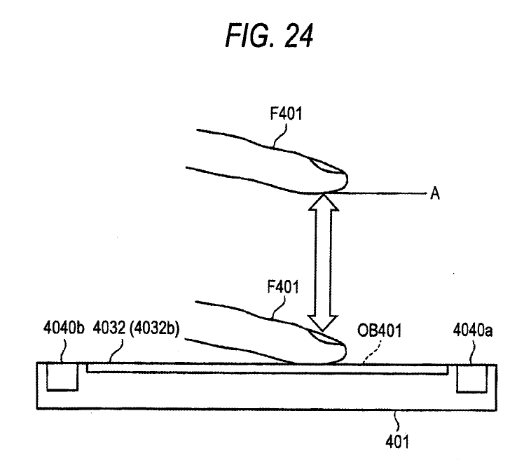

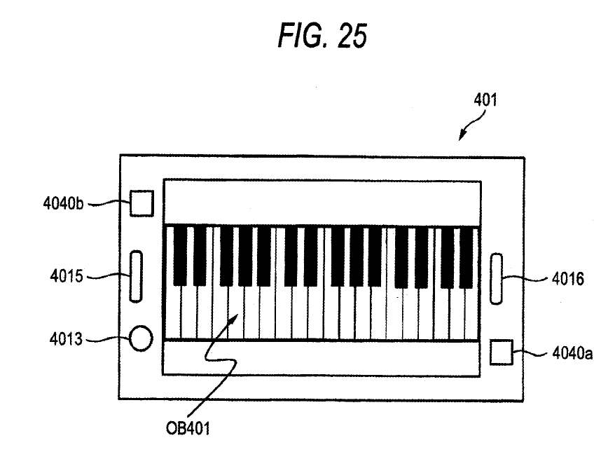

Next, the detection of the strength of operation on the object will be described with reference to FIGS. 24 and 25. FIG. 24 is a view illustrating operation on the object and the detection of the strength. FIG. 25 is a view illustrating a piano keyboard as an example of the object displayed on the display unit.

It is assumed that the touch panel 4032 displays an object OB401 as shown in FIG. 24. The following description will be made with considering a piano keyboard as an example of the object OB401 as shown in FIG. 25.

In FIG. 24, the user performs operation by bringing a finger F401 down from a point A (a first position) to the object displayed on the display unit 4032a, and returning the finger F401 to the origin position.

During this operation, the control unit 4022 monitors a displacement detected by a detecting unit. The following description describes a using of the touch sensor 4032b as an example of the detecting unit, and a value of a change in electrostatic capacitance as the displacement detected by the detecting unit.

The control unit 4022 monitors the change in the electrostatic capacitance detected by the touch sensor 4032b. According to the change in the electrostatic capacitance, when predetermined electrostatic capacitance is detected, it is considered that the finger F401 has reached (passed) the point A. Thereafter, when predetermined electrostatic capacitance different from the predetermined electrostatic capacitance detected when the finger F401 has passed the point A is detected, it is determined that the finger F401 is contact with the touch panel, and it is determined by the touch sensor 4032b where on the touch sensor 4032b is in contact with the finger F401. At this time, when there is any object displayed at the position on the touch panel in contact with the finger F401, it is determined that the finger F401 is in contact with the corresponding object.

Next, based on a displacement time that is required for the finger F401 to move from the point A to the contact position with the object, the strength of operation on the object is changed. In a case where the object is a piano keyboard as shown in FIG. 25, a sound of a key of the keyboard touched by the finger F401 is played, based on at levels of the strength. Here, the displacement time represents a time obtained based on the displacement (the change in the electrostatic capacitance) detected by the touch sensor 4032b, which is the detecting unit, from when the finger F401 was at the point A to when the finger F401 being contact with the object. The following description will be made by referring to the displacement time as the time.

In a case of operating the keyboard the finger F401, it can be considered that as the keyboard is pushed more strongly, the time required for operation becomes shorter. Therefore, in a case where the time from when the finger F401 passed the point A to when the finger F401 is contact with the keyboard which is the object is short, it is possible to determine that the keyboard has been pushed strongly; whereas, in a case where the time from when the finger F401 passed the point A to when the finger F401 is contact with the keyboard which is the object is long, it is possible to determine that the keyboard has been pushed softly.

Based on this determination result, an operation is performed such that as the strength is higher, the sound of the piano becomes larger. In this case, although the display of the object itself is not changed, it is possible to change the loudness of a sound or to change a sound outputting method, which are a physical quantity associated with the object. In addition, it is also possible to change the intensity, blinking, blinking tempo, blinking period, and the like of light as physical quantities other than a sound. In other words, an operating unit for performing an operation associated with the object is a speaker (not shown) for emitting a sound, or a touch panel 4032 capable of acting directly on the finger F401 which is the material body.

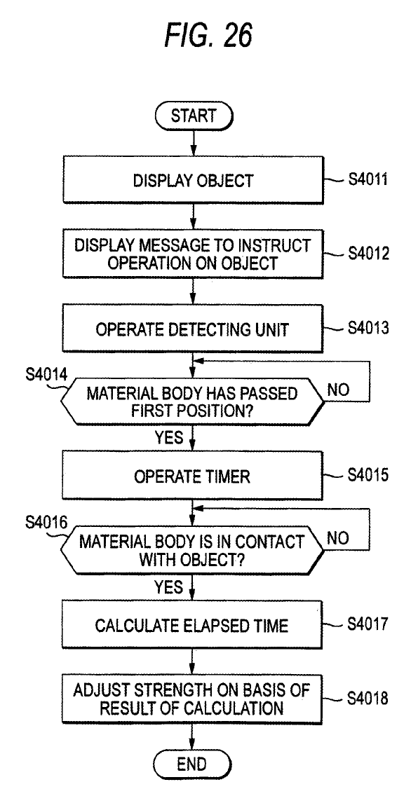

Next, a process procedure of a process of adjusting the strength of operation will be described with reference to FIG. 26. FIG. 26 is a flow chart illustrating the process procedure of the process of adjusting the strength of operation. The control unit 4022 executes the control program 4024a so as to perform the process procedure shown in FIG. 26. The process procedure shown in FIG. 26 is executed at a timing before the user first performs operation on the object, the subsequent regular timings, and the like.

As shown in FIG. 26, first, in step S4011, the control unit 4022 makes the touch panel 4032 display the object. Subsequently, in step S4012, the control unit 4022 makes the touch panel 4032 display a message to instruct operation on the object. Next, in step S4013, the control unit 4022 operates the touch sensor 4032b which is the detecting unit.

A time when the control unit 4022 operates the touch sensor 4032b may be a period having a predetermined length or a period from when the touch sensor 4032b is restored from a halt mode to when the touch sensor 4032b returns to the halt mode. Also, it is preferable to increase the sensitivity of the touch sensor 4032b after the touch sensor 4032b is restored from the halt mode until the finger F401 comes into contact with the touch panel 4032. In this case, even when the finger F401 is not in contact with the touch panel 4032, it is possible to accurately detect the finger F401.

Thereafter, when it is detected that the finger F401 is contact with the touch panel 4032, it is preferable to reduce the sensitivity of the touch sensor 4032b to a normal state. Therefore, it is possible to keep the power consumption to a minimum.

Next, in step S4014, the control unit 4022 determines whether the finger F401 which is the material body is passed the point A which is the first position. When determining that the finger F401 is not passed the point A (NO in step S4014), the control unit 4022 repeats step S4014 until the finger F401 passes the point A. Meanwhile, when it is determined that the finger F401 is passed the point A (YES in step S4014), the process proceeds to step S4015. The determination of whether the finger F401 is passed the point A is executed by determining whether the electrostatic capacitance detected by the touch sensor 4032b satisfies a predetermined value.

Subsequently, in step S4015, the control unit 4022 operates the timer 4028. Next, in step S4016, the control unit 4022 determines whether the finger F401 is in contact with the object. When the material body is not in contact with the object (NO in step S4016), the timer 4028 continues to measure the time, and the control unit 4022 continues to determine whether the finger F401 is in contact with the object. Meanwhile, when the finger F401 is in contact with the object (YES in step S4016), the process proceeds to step S4017. The determination of whether the finger F401 is in contact with the object is executed by determining whether the electrostatic capacitance detected by the touch sensor 4032b satisfies a predetermined value. The value of electrostatic capacitance, which is a determination criterion when the finger F401 is contact with the object, is larger than the electrostatic capacitance which is the determination criterion when the finger F401 has passed the point A.

In step S4017, the control unit 4022 calculates a time required after the finger F401 passed the point A until the finger F401 is contact with the object displayed on the touch panel 4032.

Next, in step S4018, the control unit 4022 adjusts the strength of operation based on the time calculated in step S4017. As the required time is shorter, the strength of operation is set to be higher. Instead of a time required for a predetermined material body to move from a predetermined first position to a contact position with the object, a time from when the predetermined material body starts to move to when the movement stops may be used.

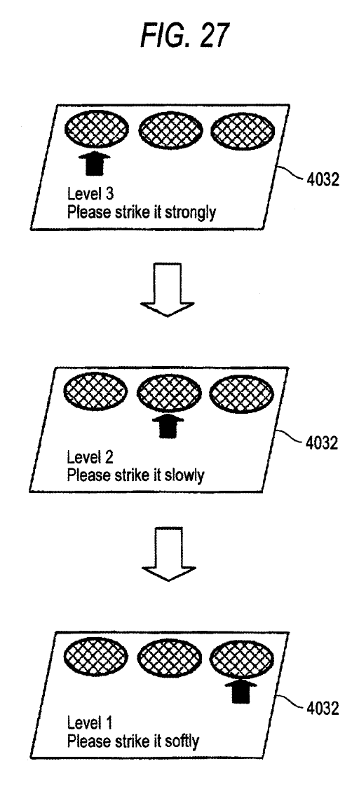

As described above, since the process of adjusting the strength of operation is executed, it is possible to determine the strength of operation according to the characteristics of the user. Also, the adjusting process may be executed for levels of the strength of operation as shown in FIG. 27. In the example shown in FIG. 27, three areas are displayed on the touch panel 4032, and the user is made strike the left area strongly, strike the central area with a medium level of strength, and strike the right area weakly. Based on the result of this, the strength of operation is adjusted. When the adjusting process is executed for levels of strength, it is possible to execute the process of adjusting the strength of operation more accurately.

As described above, in the present embodiment, the strength of user's operation is detected based on the time required for the operation or the rate calculated from the time required for the operation. Therefore, it is possible to appropriately detect the strength of user's operation.

A mode of this disclosure according to the fourth illustrative embodiment can be arbitrarily changed within the scope of this disclosure. For example, the control program 4024a according to the fourth illustrative embodiment may be divided into a plurality of modules or may be integrated with another program. Also, in the fourth illustrative embodiment, operation on the object is performed with a finger. However, the object may be operated with a tool such as a stylus.

Further, in the above-mentioned embodiment, the movement of the finger F401 is detected based on the electrostatic capacitance detected by the touch sensor 4032b. However, the movement of the finger F401 may be detected based on an image acquired by the image acquiring unit 4040.

Furthermore, in the above description, the strength of operation is determined based on the time required for the predetermined material body to move from a predetermined point to a contact position with the object. However, this disclosure is not limited thereto. For example, based on a distance from the predetermined point to the contact position with the object, and the time required for the material body to move from the predetermined point to the contact position with the object, a displacement rate may be calculated and the strength of operation may be determined. Further, as the displacement rate increases, the strength of operation may be set to be higher. Here, the displacement rate represents a rate calculated from the time obtained based on the displacement (change in the electrostatic capacitance) detected by the touch sensor 4032b, which is the detecting unit, while the finger F401 has moved from the predetermined point to the contact position with the object.

Alternatively, the strength of operation may be determined based on a displacement distance after the predetermined material body starts to move until the predetermined material body comes into contact with the object. In this case, as the displacement distance increases, the strength of operation may be set to be higher. The displacement distance can be calculated from the electrostatic capacitance detected by the touch sensor 4032b.

Alternatively, the strength of operation may be determined based on a displacement time required for the predetermined material body to move from the above-mentioned predetermined first position to a predetermined second position through the contact position with the object. In this case, as the required displacement time decreases, the strength of operation may be set to be higher. This displacement time can be calculated from the electrostatic capacitance detected by the touch sensor 4032b.

Alternatively, the strength of operation may be determined by calculating a displacement rate based on the displacement time required for the predetermined material body to move from the above-mentioned predetermined first position to the predetermined second position through the contact position with the above-mentioned object. In this case, as the required displacement rate increases, the strength of operation may be set to be higher. This displacement rate can be calculated from the electrostatic capacitance detected by the touch sensor 4032b.

Alternatively, the strength of operation may be determined based on a displacement distance after the predetermined material body starts to move until the predetermined material body comes into contact with the object and stops at a position separated from the object. In this case, as the displacement distance increases, the strength of operation may be set to be higher. The displacement distance can be calculated from the electrostatic capacitance detected by the touch sensor 4032b.

The predetermined first position may be replaced with the position where the material body starts to move, and the predetermined second position may be replaced with the position at which the material body stops after starting to move and coming into contact with the object and which is separated from the object.

In the above-mentioned embodiment, the touch sensor 4032b is used for detecting the displacement in each physical quantity occurring due to movement of the predetermined material body. However, this disclosure is not limited thereto. For example, instead of the touch sensor 4032b, a sensor using a time-of-flight (TOF) method may be used. Alternatively, an infrared sensor, a proximity sensor, or the like capable of detecting movement of the material body in a face direction when the material body is not in the non-proximity state may be disposed substantially in parallel with the movement direction of the predetermined material body, and be used. The displacement may be detected without disposing any sensor or the like at the predetermined material body. In this case, since it is unnecessary to purposely attach an acceleration sensor to the finger, or to move an electronic device having acceleration, it is possible to reduce the cost.

In the fourth illustrative embodiment, as an example of changing the operation contents according to the determined strength of operation, the piano which is a musical instrument has been used. However, this disclosure is not limited thereto. For example, this disclosure can be applied to any case, which is associated with the strength when a finger or the like moves in a space and in which adjustment on the level of strength is executed. According to the level of strength, the object may be change in any way. For example, the object may be moved, or the rate of the movement may be changed, or the object may be deformed, or the amount of deformation may be changed.

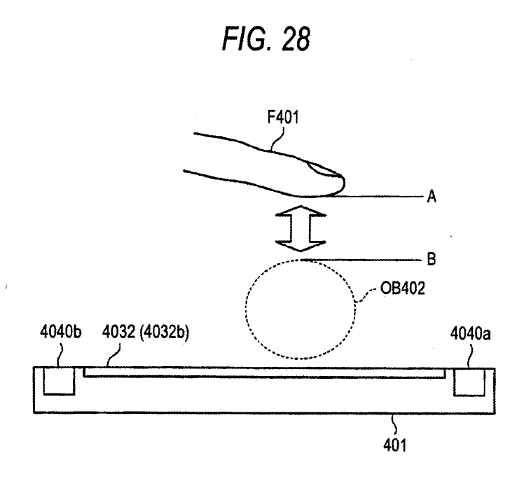

In the fourth illustrative embodiment, a 2D object is displayed on the touch panel 4032. However, this disclosure is not limited thereto. For example, the touch panel 4032 may be configured to be capable of display a 3D object. The 3D object is an image or a shape generated by using a parallax such that the image or shape can be three-dimensionally seen. A type of displaying a 3D object may be a type of performing stereovision using a tool such as glasses, or may be a type of performing stereovision by naked eyes. Assuming that the touch panel 4032 displays an object OB402 as shown in FIG. 28, since the object OB402 seems to the user to be floated in a space above the touch panel 4032, an operation on the 3D object OB402 is performed at a position separated from the touch panel 4032. In FIG. 28, the user performs operation by bringing the finger F401 down to the 3D object and returning the finger F401 to an origin position. In this case, when the finger F401 comes into contact with the 3D object or reaches a predetermined position in the 3D object, determination similar to that in the case where the finger F401 comes into contact with the object in the fourth illustrative embodiment may be made. Further, an operating unit for executing an operation associated with the 3D object is a speaker (not shown) for emitting a sound, or on a touch panel 4032 capable of acting directly on the material body, and in the space where the 3D object is displayed.

In the fourth illustrative embodiment, as the parameters based on displacements, a time, a rate, and a distance have been exemplified. However, this disclosure is not limited thereto. The parameters need only to be capable of being calculated from the displacement detected by the detecting unit.

As described above, according the configuration of the portable phone terminal 401 (electronic device) of the present embodiment, since the contents of the operation changes based on what level of strength the user operates the object with, it is possible to give a feeling of intuitive operation more realistically.

1. An electronic device comprising:
a display unit configured to display an image on a display face;
a detecting unit configured to detect a physical quantity which changes according to a distance of a material body from the display unit; and
a control unit that enlarges or reduces the image according to the physical quantity detected by the detecting unit such that the display unit display the enlarged or reduced image.

2. An electronic device according claim 1, further comprising:
a position specifying unit that specifies the position of the material body from the display unit in a direction along the display face; and
a state determining unit configured to determine whether a state of the material body is a contact state in which the material body is in contact with the display unit, or a proximity state in which the material body is positioned in an area at distances of less than a predetermined distance from the display unit, or a non-proximity state in which the material body is positioned in an area at distance of the predetermined distance or more from the display unit, based on the physical quantity detected by the detecting unit,
wherein the control unit is a display control unit that enlarges or reduces the image with centering on the position of the material body specified by the position specifying unit, based on the physical quantity detected by the detecting unit, when the state determining unit determines that the material body is in the proximity state with respect to the display unit.

3. The electronic device according to claim 2,
wherein, in a case where the state determining unit determines that the material body is in the proximity state, the display control unit enlarges the image when a distance of the material body from the display unit decreases based on the physical quantity detected by the detecting unit,
wherein, in a case where the state determining unit determines that the material body is in the proximity state, the display control unit reduces the image when the distance of the material body from the display unit increases based on the physical quantity detected by the detecting unit.

4. The electronic device according to claim 3,
wherein, in a case where the state determining unit determines that the material body is transitioned from the proximity state to the contact state, the display control unit maintains the size of the enlarged image.

5. The electronic device according to claim 4,
wherein, in a case where the state determining unit determines that the material body is transitioned from the contact state to a non-proximity state through the proximity state, the display control unit releases the reduction of the image.

6. The electronic device according to claim 2,
wherein, in a case where a time from when the state determining unit determines that the material body is in the proximity state to when the state determining unit determines that the material body is in the contact state is a predetermined time or less, the display control unit does not enlarge or reduce the image.

7. The electronic device according to claim 2,
wherein, in the case of enlarging the image, the display control unit enlarges a predetermined range of the image or the entire image, with centering on the position of the material body specified by the position specifying unit, and
wherein, in the case of reducing the image, the display control unit reduces a predetermined range of the image or the entire image, with centering on the position of the material body specified by the position specifying unit.

8. The electronic device according to claim 2,
wherein, in a case where the state determining unit determines that the material body is in the proximity state, when the position specifying unit determines that the material body is moving with respect to the display unit, the display control unit changes a center of image enlargement or reduction according to the position of the material body specified by the position specifying unit.

9. An electronic device according to claim 1,
wherein the control unit determines whether a state of the material body is a contact state in which the material body is in contact with the display unit, or a proximity state in which the material body is positioned in an area at distances of less than a predetermined distance from the display unit, or a non-proximity state in which the material body is positioned in an area at distances of the predetermined distance or more from the display unit, based on the physical quantity detected by the detecting unit,
wherein the control unit specifies the position of the material body with respect to the display unit in a direction along the display face, and
wherein the control unit enlarges or reduces the image, with centering on the specified position of the material body, based on the physical quantity detected by the detecting unit, when determining that the material body is in the proximity state.

10. An electronic device comprising:
a display unit configured to display an object;
a detecting unit configured to detect positions of a first material body and a second material body on the display unit; and
a control unit that changes display of the object when the positions of the first material body and the second material body detected by the detecting unit are in the vicinity of the object displayed on the display unit.

11. The electronic device according to claim 10,
wherein the control unit selects the object having changed in display, and
wherein, after the selecting, when the detecting unit detects a predetermined operation at a position out of an area of the object on the display unit, the control unit moves or copy the selected object to the detected position.

12. The electronic device according to claim 11,
wherein, after the selecting of the object, the control unit moves the object or an image corresponding to the object along the first material body and the second material body detected by the detecting unit, until the predetermined operation is detected.

13. The electronic device according to claim 11,
wherein, when the detecting unit detects that the first material body and the second material body come into contact with the display unit and the positions of the first material body and the second material body are in the vicinity of the object displayed on the display unit, the control unit selects the object, and
wherein, when the detecting unit detects that the first material body and the second material body moves with separated from the display unit and at least one of the first material body and the second material body comes into contact with the display unit at another position, the control unit moves or copies the selected object to the another position.

14. The electronic device according to claim 11,
wherein, when the detecting unit detects that the first material body and the second material body come into contact with the display unit and the positions of the first material body and the second material body are in the vicinity of the object displayed on the display unit, the control unit selects the object, and
wherein, when the detecting unit detects that a distance between the first material body and the second material body moving with separated from the display unit becomes larger than a predetermined distance at another position on the display unit, the control unit moves or copies the selected object to the another position.

15. The electronic device according to claim 13,
wherein, after the selecting of the object, the control unit increases sensitivity of the detecting unit until the object is moved or copied.

16. The electronic device according to claim 13,
wherein, when the first material body and the second material body moving with separated from the display unit is not detected by the detecting unit, the control unit restores the display of the object.

17. The electronic device according to claim 11,
wherein, when another object is displayed at the position where the predetermined operation is detected, the control unit does not move or copy the selected object to the detected position.

18. The electronic device according to claim 11,
wherein, when a container object capable of other objects is provided at the position where the predetermined operation is detected in a display area, the control unit moves or copies the selected object into the container object.

19. The electronic device according to claim 10,
wherein, when the detecting unit detects that the positions of the first material body and the second material body get closer to the center of the display area of the object in the vicinity of the object, the control unit changes the display of the object.

20. The electronic device according to claim 10,
wherein the detecting unit is configured to detect a position of a third material body on the display unit, and
wherein when the detecting unit detects that the positions of the first material body, the second material body, and the third material body get closer to the center of the display area of the object in the vicinity of the object, the control unit changes the display of the object.

21. The electronic device according to claim 10,
wherein, when the detecting unit detects that the position of the first material body gets closer to the position of the second material body, which is stationary on or in the vicinity of the display area of the object, the control unit changes the display of the object.

22. The electronic device according to claim 10,
wherein the display unit three-dimensionally displays an object in a predetermined area, and
wherein the detecting unit detects the positions of the first material body and the second material body within the predetermined area.

23-39. (canceled)
